(19) United States
(12) Patent Application Publication
(10) Pub. No.: US 2025/0252406 A1
(43) Pub. Date: Aug. 7, 2025

(54) AUTOMATED CALENDARING BASED ON DEVICE USAGE

(71) Applicant: Connoisseur Technology Holdings, LLC, Denver, CO (US)

(72) Inventors: Ryan Newburn, Denver, CO (US); Ognjen Grba, Calgary (CA)

(73) Assignee: Connoisseur Technology Holdings, LLC, Denver, CO (US)

(21) Appl. No.: 19/046,476

(22) Filed: Feb. 5, 2025

Related U.S. Application Data
(60) Provisional application No. 63/549,997, filed on Feb. 5, 2024.
(60) Provisional application No. 63/549,998, filed on Feb. 5, 2024.
(60) Provisional application No. 63/550,000, filed on Feb. 5, 2024.
(60) Provisional application No. 63/550,005, filed on Feb. 5, 2024.
(60) Provisional application No. 63/550,006, filed on Feb. 5, 2024.
(60) Provisional application No. 63/550,008, filed on Feb. 5, 2024.

(51) Int. Cl. G06Q 10/1091; G06Q 10/1093

(52) U.S. Cl. CPC G06Q 10/1091; G06Q 10/1093

(57) ABSTRACT

A method of automatically generating a calendar entry based on usage of a device may include automatically determining, by the device, a usage state of an application on the device for a first date and time period. The method may include automatically determining, based on the usage state, a user activity for the first date and time period. The method may include automatically generating, based on the usage state, the calendar entry for a second date and time period similar to the first date and time period of the user activity. The calendar entry may include an activity name and a duration.

### CROSS-REFERENCES

This application claims the benefits of U.S. Provisional App. No. 63/549,997 by Ryan Newburn and Ognjen Grba entitled “DISPLAY AND UX BASED ON USER CHRONOTYPE,” filed Feb. 5, 2024; U.S. Provisional App. No. 63/549,998 by Ryan Newburn and Ognjen Grba entitled “AUTOMATED CALENDARING BASED ON DEVICE USAGE,” filed Feb. 5, 2024; U.S. Provisional App. No. 63/550,000 by Ryan Newburn and Ognjen Grba entitled “OBJECTIVE-ORIENTED USER EXPERIENCE,” filed Feb. 5, 2024; U.S. Provisional App. No. 63/550,005 by Ryan Newburn and Ognjen Grba entitled “INFLUENCER-BASED USER EXPERIENCE,” filed Feb. 5, 2024; U.S. Provisional App. No. 63/550,007 by Ryan Newburn and Ognjen Grba entitled “RELATIONSHIP-BASED APPLICATION CONTENT,” filed Feb. 5, 2024; and U.S. Provisional App. No. 63/550,008 by Ryan Newburn and Ognjen Grba entitled “APPLICATION-LEVEL OPERATING SYSTEM,” filed Feb. 5, 2024. The entire contents of the foregoing referenced applications are incorporated herein by reference.

### BACKGROUND

Personal devices such as smartphones, tablets, and personal computers have drastically changed the landscape of human activity. Specifically, such devices allow people to do more in less time with fewer resources. However, the advances in personal device technology have resulted in an onslaught of information and resources that can be overwhelming. Indeed, for technologies related to personal device activities such as social media use, scientists have noted dramatic changes in how people interact with each other and changes in how the human brain operates. What is lacking is a means for efficiently managing and integrating the resources and technologies available for personal devices.

### SUMMARY

Implementations of the present disclosure may include a method of automatically generating a calendar entry based on usage of a device. The method may include automatically determining, by the device, a usage state of an application on the device for a first date and time period. Based on the usage state, a user activity may be determined for the first date and time period. Various implementations may include automatically generating, based on the usage state, a calendar entry for a second date and time period similar to the first date and time period of the user activity. The calendar entry may include an activity name and a duration.

In some implementations, the method may include automatically determining a current date and time. In response to the current date and time matching the calendar entry, the application may automatically be set to the usage state.

In some implementations, the method may include automatically determining a location of the device for the first date and time period. The user activity may be automatically determined further based on the location. The method may include automatically generating the calendar entry further based on the location. In some implementations, the method may include automatically determining a location of the device for the first date and time period. Various implementations may also include automatically determining the user activity further based on the location. A current date and time and a current location may also be automatically determined. In response to the current date and time matching the calendar entry, and further in response to the current location matching the location of the client device for the first date and time period, the application may be automatically set to the usage state.

In some implementations, the method may be implemented by an application-level operating system of the device. The application-level operating system may include a device module that communicates with a native operating system of the device. The application-level operating system may also include an application module that communicates with the application. The application-level operating system may include a UX module that generates a UX based on device data communicated from the native operating system to the application-level operating system and application data communicated from the application. The application-level operating system may include a display module that generates a user interface on the device based on the UX.

In some implementations, the method may include displaying the calendar entry on the device via a calendar application on the device that may be implemented according to a customized display and UX based on a chronotype of a user associated with the device.

Implementations of the present disclosure may include a method of generating a composite calendar based on a scheduled activity and an unscheduled activity. The method may include displaying, via a user interface (UI) of a device, a calendar interface associated with a calendar module implemented on the device. An input may be received corresponding to a first calendar entry. The first calendar entry may be stored on the device. Various implementations may include automatically determining, by the device, a usage state of the device for a first date and time period. Various implementations may also include automatically determining, based on the usage state, a user activity for the first date and time period. A second calendar entry for a second date and time period similar to the first date and time period of the user activity may be automatically generated based on the usage state. The second calendar entry may be stored on the device. The calendar interface may show the first calendar entry after the first calendar entry is made, and/or the second calendar entry after the second calendar entry is made.

In some implementations, the first calendar entry may include a first device usage entry that indicates the usage state of the device for the first calendar entry. Similarly, in some implementations, the second calendar entry may include a second device usage entry that indicates the usage state of the device for the second calendar entry.

The method may include automatically determining, by the device, a current date and time. In response to the current date and time matching the first calendar entry, the method may include automatically setting the device to the usage state for the first calendar entry. Similarly, in response to the current date and time matching the second calendar entry, the method may include automatically setting the device to the usage state for the second calendar entry.

In some implementations, the first calendar entry and/or the second calendar entry may include an event location. For example, in some implementations, the method may include automatically determining a location of the device for the first date and time period. Generating the second calendar entry may include generating an event location that matches the location of the device for the first date and time period. The method may include automatically determining, by the device, a current date and time and a current location of the device. In response to the current date and time and the current location matching the first calendar entry, the method may include automatically setting the device to the usage state for the first calendar entry. Similarly, in response to the current date and time and the current location matching the second calendar entry, the method may include automatically setting the device to the usage state for the second calendar entry.

In some implementations, the method may be implemented by an application-level operating system of the device. The application-level operating system may include a device module that communicates with a native operating system of the device. The application-level operating system may include an application module that communicates with a calendar application on the device. The calendar application may generate the calendar interface on the UI. The application-level operating system may include a UX module that generates a UX based on device data communicated from the native operating system to the application-level operating system and application data communicated from the calendar application. The application-level operating system may include a display module that generates the UI on the device based on the UX. In some implementations, the calendar module may be implemented on the device according to a customized display and UX based on a chronotype of a user associated with the device.

Implementations of the present disclosure may include a method of automatically generating a calendar entry based on a function executed in another application on a device. The method may include automatically determining, by a calendar application implemented on the device, a function executed by the other application on the device. The other application may include one or more of a communication application, a health application, a finance application, and a task application. The calendar application may automatically determine a user activity for a first date and time period associated with the function. The method may include automatically generating, based on the user activity, a calendar entry for a second date and time period similar to the first date and time period. The calendar entry may include an activity name and a duration.

In some implementations, the calendar application has permissions to read data associated with the other application, create new data in the other application, provide inputs to the other application, and receive outputs from the other application. The method may include automatically determining, by the calendar application, a current date and time. In response to the current date and time matching the calendar entry, the function may be automatically executed by the other application.

The method may include automatically determining a location of the device for the first date and time period. In some implementations, generating the calendar entry may include generating an event location that matches the location of the device for the first date and time period.

The method may include automatically determining, by the calendar application, a current date and time and a current location of the device. In response to the current date and time and the current location matching the calendar entry, the function may be automatically executed by the other application.

In some implementations, the calendar application may be implemented on the device according to a customized display and UX based on a chronotype of a user associated with the device.

### BRIEF DESCRIPTION OF THE DRAWINGS

The present description will be understood more fully when viewed in conjunction with the accompanying drawings of various examples of digital, AI-driven lifestyle management. The description is not meant to limit the digital, AI-driven lifestyle management system to the specific examples. Rather, the specific examples depicted and described are provided for explanation and understanding of digital, AI-driven lifestyle management. Throughout the description the drawings may be referred to as drawings, figures, and/or FIGs.

FIG. 1 illustrates a device of a digital, AI-driven lifestyle management system, according to an implementation.

FIG. 2 illustrates a digital, AI-driven lifestyle management system, according to an implementation.

FIG. 3 illustrates a set of computer-implemented modules of a digital, AI-driven lifestyle management system, according to an implementation.

FIG. 4 is a flowchart that describes a method of generating a customized display and user experience, according to some implementations of the present disclosure.

FIG. 5 is a flowchart that further describes the method of generating a customized display and UX from FIG. 4, according to some implementations of the present disclosure.

FIGS. 6A to 6B are flowcharts that describe a method of training an AI engine, according to some implementations of the present disclosure.

FIG. 7 is a flowchart that further describes the method of training an artificial intelligence from FIG. 6A, according to some implementations of the present disclosure.

FIG. 8 is a flowchart that describes a method of training an artificial intelligence, according to some implementations of the present disclosure.

FIG. 9 is a flowchart that further describes the method of training an artificial intelligence from FIG. 8, according to some implementations of the present disclosure.

FIG. 10 is a flowchart that describes a method of automatically generating a calendar entry, according to some implementations of the present disclosure.

FIG. 11 is a flowchart that further describes the method of automatically generating a calendar entry from FIG. 10, according to some implementations of the present disclosure.

FIG. 12 is a flowchart that further describes the method of automatically generating a calendar entry from FIG. 10, according to some implementations of the present disclosure.

FIG. 13 is a flowchart that further describes the method of automatically generating a calendar entry from FIG. 10, according to some implementations of the present disclosure.

FIG. 14 is a flowchart that describes a method of generating a composite calendar, according to some implementations of the present disclosure.

FIG. 15 is a flowchart that further describes the method of generating a composite calendar from FIG. 14, according to some implementations of the present disclosure.

FIG. 16 is a flowchart that further describes the method of generating a composite calendar from FIG. 14, according to some implementations of the present disclosure.

FIG. 17 is a flowchart that describes a method of automatically generating a calendar entry, according to some implementations of the present disclosure.

FIG. 18 is a flowchart that describes a method of automatically generating a calendar entry based on a function executed in another application on a device, according to some implementations of the present disclosure.

FIG. 19 is a flowchart that describes a method of generating an objective-oriented UX, according to some implementations of the present disclosure.

FIG. 20 is a flowchart that further describes the method of generating an objective-oriented user experience from FIG. 19, according to some implementations of the present disclosure.

FIG. 21 is a flowchart that further describes the method of generating an objective-oriented user experience from FIG. 19, according to some implementations of the present disclosure.

FIG. 22 is a flowchart that further describes the method of generating an objective-oriented user experience from FIG. 19, according to some implementations of the present disclosure.

FIG. 23 is a flowchart that further describes the method of generating an objective-oriented user experience from FIG. 19, according to some implementations of the present disclosure.

FIG. 24 is a flowchart that describes a method of generating an objective-oriented user experience, according to some implementations of the present disclosure.

FIG. 25 is a flowchart that further describes the method of generating an objective-oriented user experience from FIG. 24, according to some implementations of the present disclosure.

FIG. 26 is a flowchart that further describes the method of generating an objective-oriented user experience from FIG. 24, according to some implementations of the present disclosure.

FIG. 27 is a flowchart that describes a method of generating an objective-oriented user experience, according to some implementations of the present disclosure.

FIG. 28 is a flowchart that further describes the method of generating an objective-oriented user experience from FIG. 27, according to some implementations of the present disclosure.

FIG. 29 is a flowchart that describes a method of implementing an influencer-based user experience, according to some implementations of the present disclosure.

FIG. 30 is a flowchart that further describes the method of implementing an influencer-based user experience from FIG. 29, according to some implementations of the present disclosure.

FIG. 31 is a flowchart that further describes the method of implementing an influencer-based user experience from FIG. 29, according to some implementations of the present disclosure.

FIG. 32 is a flowchart that further describes the method of implementing an influencer-based user experience from FIG. 29, according to some implementations of the present disclosure.

FIG. 33 is a flowchart that further describes the method of implementing an influencer-based user experience from FIG. 29, according to some implementations of the present disclosure.

FIG. 34 is a flowchart that describes a method of generating a lifestyle-based advertisement, according to some implementations of the present disclosure.

FIG. 35 is a flowchart that further describes the method of generating a lifestyle-based advertisement from FIG. 34, according to some implementations of the present disclosure.

FIG. 36 is a flowchart that describes a method of generating a lifestyle-based advertisement, according to some implementations of the present disclosure.

FIG. 37 is a flowchart that describes a method of determining application content based on user relationships, according to some implementations of the present disclosure.

FIG. 38 is a flowchart that describe a method of determining application content based on user relationships, according to some implementations of the present disclosure.

FIG. 39 is a flowchart that further describes the method of determining application content from FIG. 38, according to some implementations of the present disclosure.

FIG. 40 is a flowchart that further describes the method of determining application content from FIG. 38, according to some implementations of the present disclosure.

FIG. 41 is a flowchart that describes a method of determining application content based on user relationships, according to some implementations of the present disclosure.

FIG. 42 is a flowchart that further describes the method of determining application content from FIG. 41, according to some implementations of the present disclosure.

FIG. 43 is a flowchart that further describes the method of determining application content from FIG. 41, according to some implementations of the present disclosure.

FIG. 44 is a block diagram that describes an application-level operating system, according to some implementations of the present disclosure.

FIG. 45 is a flowchart that describes a method of implementing an application-level operating system on a device, according to some implementations of the present disclosure.

FIG. 46 is a flowchart that further describes the method of implementing an application-level operating system on a device from FIG. 45, according to some implementations of the present disclosure.

FIG. 47 is a block diagram that describes an application-level operating system, according to some implementations of the present disclosure.

FIG. 48 illustrates a user statistics display, according to an implementation.

### DETAILED DESCRIPTION

Digital, AI-driven lifestyle management as disclosed herein will become better understood through a review of the following detailed description in conjunction with the figures. The detailed description and figures provide merely examples of the various implementations of a digital, AI-driven lifestyle management system. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

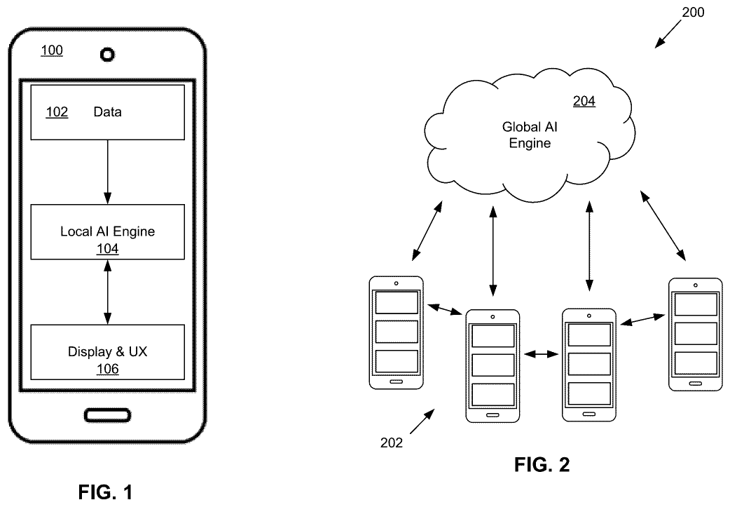

FIG. 1 illustrates a device 100 of a digital, AI-driven lifestyle management system, according to an implementation. The device 100 stores data 102 that is used by a local AI engine 104 to generate a customized display and UX 106 for the device 100. Such may be performed according to any of various implementations of the methods disclosed herein.

The device 100 may be a user-oriented computing device such as a smartphone, a personal computer, a tablet computer, and so forth. In general, the device 100 may, without limitation, include such elements as a user interface, a memory, a processor, various sensors, a locator, and one or more communicators. The various sensors may include one or more of a microphone, an accelerometer, a gyroscope, a magnetometer, a biometric sensor, a proximity sensor, an ambient light sensor, and so forth. The locator may include, for example, a GPS.

Various of the devices disclosed herein, including device 100, may include a user interface for outputting information in a format perceptible by a user and receiving input from the user. The user interface may include a display screen such as a light-emitting diode (LED) display, an organic LED (OLED) display, an active-matrix OLED (AMOLED) display, a liquid crystal display (LCD), a thin-film transistor (TFT) LCD, a plasma display, a quantum dot (QLED) display, and so forth. The user interface may include an acoustic element such as a speaker, a microphone, and so forth. The user interface may include a button, a switch, a keyboard, a touch-sensitive surface, a touchscreen, a camera, a fingerprint scanner, and so forth. The touchscreen may include a resistive touchscreen, a capacitive touchscreen, and so forth.

The device 100 and various other devices disclosed herein, including user devices and server devices, may include one or more processors. Such processors may have volatile and/or persistent memory. The processors may generate an output based on an input. For example, the processors may receive an electronic and/or digital signal. The processors may read the signal and perform one or more tasks with the signal, such as performing various functions with data in response to input received by the processors. The processors may read from memory information needed to perform various functions, such as method steps disclosed herein. The processors may send an output signal to memory, and the memory may store data according to the signal output by the processors.

The processors may be and/or include a processor, a microprocessor, a computer processing unit (CPU), a graphics processing unit (GPU), a neural processing unit, a physics processing unit, a digital signal processor, an image signal processor, a synergistic processing element, a field-programmable gate array (FPGA), a sound chip, a multi-core processor, and so forth. As used herein, “processor,” “processing component,” “processing device,” and/or “processing unit” may be used generically to refer to any or all of the aforementioned specific devices, elements, and/or features of the processors.

The device 100 and various other devices disclosed herein, including user devices and server devices, may include memory. The memory may have volatile and/or persistent memory. The memory may be and/or include a computer processing unit register, a cache memory, a magnetic disk, an optical disk, a solid-state drive, and so forth. The memory may be configured with random access memory (RAM), read-only memory (ROM), static RAM, dynamic RAM, masked ROM, programmable ROM, erasable and programmable ROM, electrically erasable and programmable ROM, and so forth. As used herein, “memory,” “memory component,” “memory device,” and/or “memory unit” may be used generically to refer to any or all of the aforementioned specific devices, elements, and/or features of the memory.

The device 100 and various other devices disclosed herein, including user devices and server devices, may include one or more communicators. The communicators may include, for example, a networking chip, one or more antennas, and/or one or more communication ports. The communicators may generate radio frequency (RF) signals and transmit the RF signals via one or more of the antennas. The communication device may receive and/or translate the RF signals. The communicators may transceive the RF signals. The RF signals may be broadcast and/or received by the antennas.

The communicators may generate electronic signals and transmit the RF signals via one or more of the communication ports. The communicators may receive the RF signals from one or more of the communication ports. The electronic signals may be transmitted to and/or from a communication hardline by the communication ports. The communicators may generate optical signals and transmit the optical signals to one or more of the communication ports. The communicators may receive the optical signals and/or may generate one or more digital signals based on the optical signals. The optical signals may be transmitted to and/or received from a communication hardline by the communication port, and/or the optical signals may be transmitted and/or received across open space by the networking device.

The communicators may include hardware and/or software for generating and communicating signals over a direct and/or indirect network communication link. For example, the communicators may include a USB port and a USB wire, and/or an RF antenna with Bluetooth programming installed on a processor, such as the processing component, coupled to the antenna. In another example, the communicators may include an RF antenna and programming installed on a processor, such as the processing device, for communicating over a Wifi and/or cellular network. As used herein, “communicator,” “communication device” “communication component,” and/or “communication unit” may be used generically herein to refer to any or all of the aforementioned elements and/or features of the communicators.

FIG. 2 illustrates a digital, AI-driven lifestyle management system 200, according to an implementation. The digital, AI-driven lifestyle management system 200 may include one or more user devices 202 (which may be the same as or similar to the device 100 described regarding FIG. 1) and a server device 204. Data from the user devices 202 may be communicated to the server device 204. The server device 204 may have implemented thereon a global AI engine that processes the data and generates other data. The server device 204 may communicate the other data to one or more of the user devices 202, which may use the data received from the server device 204 to execute various functions.

The digital, AI-driven lifestyle management system 200 may be web-based. One or more of the user devices 202 may access the server device 204 via an online portal. The online portal may, in various implementations, be set up and/or managed by an application server. The application server may be implemented on the server device 204 or may be implemented on another server device. The digital, AI-driven lifestyle management system 200 may be implemented using a public internet. The digital, AI-driven lifestyle management system 200 may be implemented using a private intranet. Elements of the digital, AI-driven lifestyle management system 200 may be physically housed at a location remote from an entity that owns and/or operates the digital, AI-driven lifestyle management system 200. For example, various elements of the digital, AI-driven lifestyle management system 200 may be physically housed at a public service provider such as a web services provider. Elements of the digital, AI-driven lifestyle management system 200 may be physically housed at a private location, such as a location occupied by the entity that owns and/or operates the digital, AI-driven lifestyle management system 200.

The server device 204 may include a physical server and/or a virtual server. For example, the server device 204 may include one or more bare-metal servers. The bare-metal servers may be single-tenant servers or multiple tenant servers. In another example, the server device 204 may include a bare metal server partitioned into two or more virtual servers. The virtual servers may include separate operating systems and/or applications from each other. In yet another example, the server device 204 may include a virtual server distributed on a cluster of networked physical servers. The virtual servers may include an operating system and/or one or more applications installed on the virtual server and distributed across the cluster of networked physical servers. In yet another example, the server device 204 may include more than one virtual server distributed across a cluster of networked physical servers.

The term “server” may refer to functionality of a device and/or an application operating on a device. For example, an application server may be programming instantiated in an operating system installed on a memory device and run by a processing device. The application server may include instructions for receiving, retrieving, storing, outputting, and/or processing data. A processing server may be programming instantiated in an operating system that receives data, applies rules to data, makes inferences about the data, and so forth. Servers referred to separately herein may be instantiated in the same operating system and/or on the same device. Separate servers may be instantiated in the same application or in different applications.

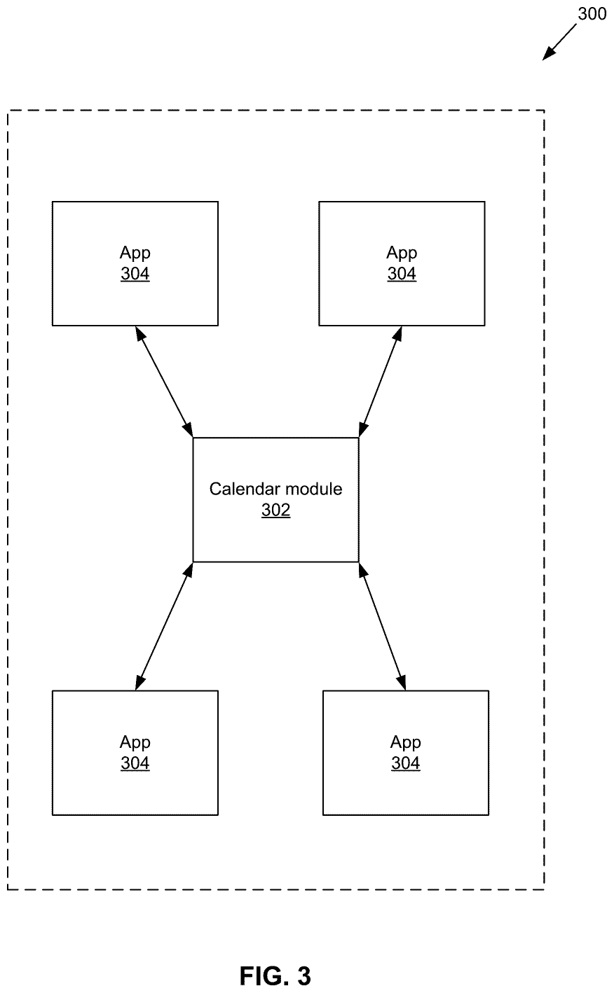

FIG. 3 illustrates a set of computer-implemented modules 300 of a digital, AI-driven lifestyle management system, according to an implementation. The set of computer-implemented modules 300 may include a calendar module 302 and various peripheral modules 304. The various peripheral modules 304 may communicate with the calendar module 302. The calendar module 302 may control various functions performed by one or more of the various peripheral modules 304. For example, one of the various peripheral modules 304 may include a health module. The calendar module 302 may control when the health module displays certain information. As a specific example, the calendar module 302 may control the timing of certain notifications by the health module.

As another example, one of the various peripheral modules 304 may include an audio module. The calendar module 302 may control the timing of when the audio module plays music or other audio associated with the audio module. As a specific example, the calendar module 302 may include a workout schedule for a user of a device that implements the set of computer-implemented modules 300. The audio module may communicate to the calendar module 302 data that indicates the user listens to workout music during the user's workouts. The calendar module 302 may automatically send a control signal to the audio module prompting the audio module to play the workout music during the user's scheduled workouts.

The set of computer-implemented modules 300 may be implemented through one or more of various combinations of processors and memory. Data may be communicated between the modules using one or more of the various communicators described above.

Various methods are disclosed below. The methods may be implemented by the devices, systems, and/or modules described above. For example, inputs indicated as being received in a method may be input at the device 100, user devices 202, and/or server device 204. Data may be received at the device 100, user devices 202, and/or server device 204. Data corresponding to various inputs, and other data may be stored in memory. Determinations may be outputs generated by the processors based on data stored in memory. Outputs generated in the methods may be output to the device 100, user devices 202, and/or server device 204. In general, data described in the methods may be stored and/or processed by various of the elements described above.

Various aspects of the methods and systems disclosed herein may be referred to as “data.” Data may be used to refer generically to modes of storing and/or conveying information. Accordingly, data may refer to textual entries in a table of a database. Data may refer to alphanumeric characters stored in a database. Data may refer to machine-readable code. Data may refer to images. Data may refer to audio. Data may refer to, more broadly, a sequence of one or more symbols. The symbols may be binary. Data may refer to a machine state that is computer-readable. Data may refer to human-readable text.

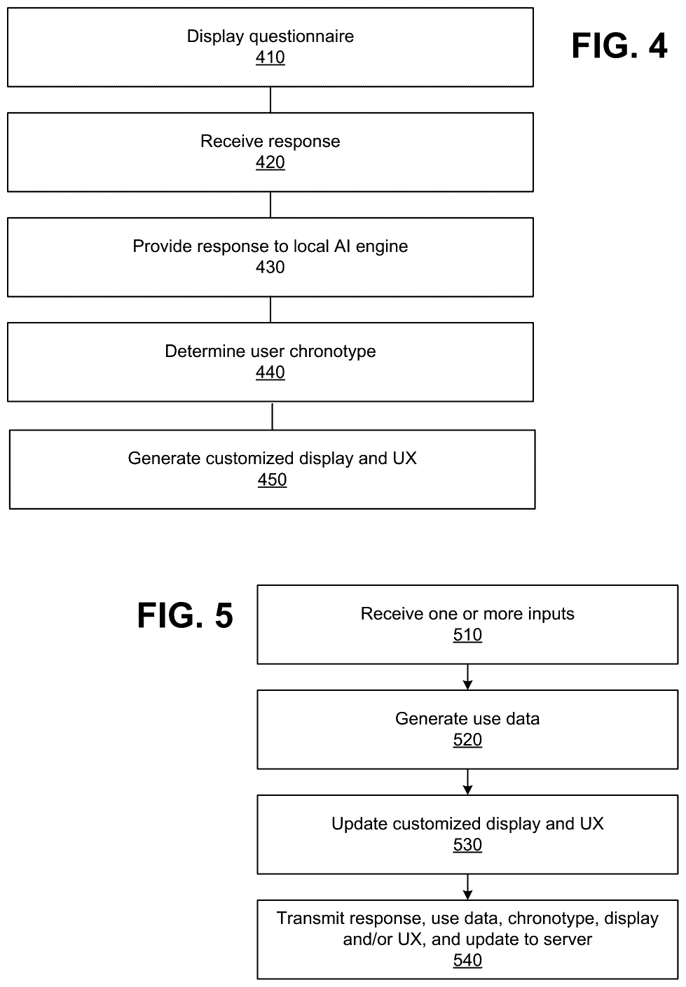

FIG. 4 is a flowchart that describes a method of generating a customized display and UX, according to some implementations of the present disclosure. In some implementations, at 410, the method may include displaying an emotional design questionnaire. The questionnaire may be displayed via a UI of a user device. At 420, the method may include receiving a response to the emotional design questionnaire. The response may be received via the UI. At 430, the method may include providing the response to a local AI engine, which may be implemented on the user device. The local AI engine may be trained to determine a user chronotype based on the response to the emotional design questionnaire. The AI engine may be trained to generate a customized display and UX based on the user chronotype. At 440, the method may include determining the user chronotype based on the response. The user chronotype may be determined by the local AI engine. At 450, the method may include generating the customized display and UX for the user device based on the user chronotype. The customized display and UX may be generated by the local AI engine.

The emotional design questionnaire may include a set of multiple-choice questions. The questions and answer choices may be displayed on the user device. The questions and answer choices may be designed to determine a chronotype of the user. For example, a question may ask, “What time do you usually go to bed?” Accompanying answer choices may include “Before 10 pm,” “10 pm-12 am,” and/or “After 12 am.” A question may ask “What time do you usually wake up?” Accompanying answer choices may include “Before 6 am,” “6 am-8 am,” and/or “After 8 am.” A question may ask, “When do you feel most productive?” Accompanying answer choices may include “Morning,” “Afternoon,” and/or “Evening.” A question may ask, “What's your preference for exercise?” Accompanying answer choices may include “Morning,” “Afternoon,” and/or “Evening.” A question may ask, “How do you feel after a large evening meal?” Accompanying answer choices may include “Energized,” “Neutral,” and/or “Sleepy.” A question may ask, “When do you prefer socializing?” Accompanying answer choices may include “Morning,” “Afternoon,” and/or “Evening.” A question may ask, “When is the best time for mentally demanding tasks?” Accompanying answer choices may include “Morning,” “Afternoon,” and/or “Evening.” A question may ask, “How does your mood fluctuate during the day?” Accompanying answer choices may include “More positive in the morning,” “Stays consistent,” and/or “More positive in the evening.” A question may ask, “When do you prefer family time?” Accompanying answer choices may include “Morning,” “Afternoon,” and/or “Evening.” A question may ask, “Do you feel energized by morning light?” Accompanying answer choices may include “Yes” and/or “No.” A question may ask, “When do you usually consume caffeine?” Accompanying answer choices may include “Morning,” “Afternoon,” and/or “Evening.” A question may ask, “How consistent is your daily routine?” Accompanying answer choices may include “Very consistent, “Somewhat consistent,” and/or “Inconsistent.” A question may ask, “How adaptable are you to schedule changes?” Accompanying answer choices may include “Very adaptable,” “Somewhat adaptable,” and/or “Not adaptable.”

In some implementations, the emotional design questionnaire may include questions that prompt the user to complete a statement or thought. For example, a question may start with the statement “You consider yourself: ”. Accompanying answer choices may include “A morning person,” “An evening person,” and/or “Neither.”

In some implementations, the emotional design questionnaire may allow for natural language responses, such as typed or spoken responses. For example, the questionnaire may include any of the above questions, or other similarly-designed questions. The user may answer the question by speaking or typing their response. The AI engine may be trained to analyze the natural language input and/or categorize the response. The categories may be the same as or similar to the answer choices described above.

As used herein, “AI engine” may refer to one or more sets of computer-readable instructions based on one or more sets of data and/or one or more AI models. The one or more AI models may include, for example, a machine learning model, an artificial neural network model, a deep learning model, a linear regression model, a logistic regression model, a decision tree model, a random forest model, a Bayes model, a naïve Bayes model, a k-nearest neighbor model, a linear discriminant analysis model, a natural language processing model, a sentiment analysis model, or a general intelligence model.

An AI engine as disclosed herein may operate by receiving data, processing the data, and generating other data. The generated data may be generated in response to the receipt and processing of the initial data. Processing may include making various determinations based on training of the AI engine. In general, a “determination” refers to any process or set of processes by which the AI engine decides how to handle data provided to it. “Determination” may also refer to generating output data as a result of processing input data. For example, the AI engine may determine that an input is a natural language input based on one or more characteristics of the input. The AI engine may process the natural language input using an NLP model and output data indicative of one or more natural language characteristics of the input. The output may be used as an input for another portion of the AI engine to make further determinations regarding the input. Multiple inputs to the AI engine may be combined in making a determination. For example, communication data regarding a text message sent from a user to another person may include the date, time, and type of communication, along with the content of the communication. The AI engine may process metadata of the communication separately from content data, e.g., by using different data processing models, and may combine the outputs of those models to make further determinations and/or generate other data.

The AI engine may be trained to have general intelligence or may be trained with specific intelligence. The AI engine may be trained to make specific determinations based on data provided to it, and/or to generate other data based on the determinations it makes. For example, the AI engine may be specifically trained to determine a user chronotype based on a response to an emotional design questionnaire. The AI engine may be trained to generate a customized display and/or UX based on the user chronotype. The AI engine may be trained to determine application content based on the user chronotype. The content may be associated with one or more applications, which applications may be implemented on a device associated with the user. The AI engine may be trained to update the customized display and/or UX based on use data associated with the customized display and/or UX. The AI engine may be trained to determine features of the customized display and/or UX based on data associated with one or more applications implemented on a device associated with the user, e.g., a calendar application, a finance or personal application, a health application, and so forth. The AI engine may be trained to determine features of the customized display and/or UX based on data indicative of an objective of a user of the device on which the customized display and/or UX is implemented. The AI engine may be trained to determine an evolution of the customized display and/or UX based on data indicative of the objective and/or a current status of the user relative to the objective. The AI engine may be trained to determine an activity for a user based on data indicative of the objective and/or current status of the user relative to the objective. The AI engine may be trained to determine the activity based on data indicative of a personal goal and/or a lifestyle goal of the user. The AI engine may be trained to determine whether the personal and/or lifestyle goal is associated with a relationship between the user and another person or entity.

The AI engine may be trained to determine application content for a specific application. The determination may be based on data indicative of one or more activities engaged in by the user and/or another person or entity. The determination may be based on data indicative of a relationship between the user and another person or entity. The AI engine may be trained to determine a relationship between the user and another person or entity. The AI engine may make such a determination based on data associated with the user and data associated with the other person or entity. The AI engine may be trained to determine the relationship based on data directly indicative of the relationship. The AI engine may be trained to determine the relationship based on communication data associated with the user and/or the other person or entity. The AI engine may be trained to determine the relationship based on UX data associated with the user and/or the other person or entity. The AI engine may be trained to determine whether data associated with a user or user device, e.g., UX data, is related to data associated with an advertiser, advertisement, an offering, a product, and/or a service. The AI engine may be trained to determine whether data associated with a user's calendar or schedule is related to data associated with an advertiser, advertisement, an offering, a product, and/or a service. The AI may be trained to determine whether data associated with the user is related to data associated with an influencer.

As used herein, “UX” may refer to one or more design elements of a device or aspect of a device (e.g., hardware or software) that, when combined, together create an experience for a user interacting with a device. The one or more design elements may include a strategy element that corresponds to one or more objectives of the user and/or one or more objectives of the aspect of the device the user is interacting with. The one or more design elements may include a scope element that corresponds to features, information, and/or functionality of the aspect of the device the user is interacting with. The one or more design elements may include a structure element that corresponds to an architecture for how the user may interact with the aspect of the device. The one or more design elements may include a skeleton element that corresponds to a visual arrangement of functional elements the user may interact with. The one or more design elements may include a surface element that corresponds to a visual appearance of the aspect of the device the user is interacting with.

As used herein, “UI” or “display” (noun) may refer to the surface element of the UX. When used together, e.g., “customized display and UX” or “UX module” and “display module,” the term “UX” may refer to the strategy, scope, structure, and skeleton elements of the UX, and “UI” or “display” may refer to the surface element of the UX.

As used herein, “chronotype” may refer to the behavioral manifestation of a myriad of

physical processes underlying a user's circadian rhythm. A user's chronotype may be defined along a spectrum from morningness to eveningness. Individuals that exhibit a morningness chronotype tend to wake up earlier in the morning and go to sleep earlier in the evening. Individuals that exhibit an eveningness chronotype tend to wake up later in the morning and go to sleep later in the evening. Normal variation in chronotype encompasses sleep-wake cycles that are two to three hours later in evening types than morning types.

As used herein, “emotional design” may refer to a process or system of developing emotions that result in positive UXs. An aspect of creating a positive UX may be aligning the UX with the user's chronotype. The emotional design questionnaire may include questions that evaluate a user's chronotype. By evaluating the user's chronotype, a customized display and UX may be generated that anticipates and accommodates the user's needs and responses to the generated UX.

Accordingly, different responses to the emotional design questionnaire may result in different customized displays and UXs being generated. In some implementations, a first chronotype may correspond to a first customized display and UX, a second chronotype may correspond to a second customized display and UX, a third chronotype may correspond to a third customized display and UX, and a fourth chronotype may correspond to a fourth customized display and UX. The first, second, third, and fourth customized display and UX may be different from each other in one or more of color scheme, button size, button placement, widget size, widget placement, application placement, notification settings, navigation settings, tone of information presented, type of information presented, type of functionality, visual arrangement of functional aspects of the UX, objectives for the user, and/or objectives for the UX, to name a few.

For example, the first chronotype may be a morningness chronotype. The second chronotype may be an eveningness chronotype. The third chronotype may be a morningness-eveningness chronotype, where the user's circadian rhythm more closely resembles the morningness chronotype than the eveningness chronotype but is later than the morningness chronotype. The fourth chronotype may be an eveningness-morningness chronotype, where the user's circadian rhythm more closely resembles the eveningness chronotype than the morningness chronotype but is earlier than the eveningness chronotype. Other methods disclosed herein describe how to train the local AI engine, or a global AI engine, to generate the customized display and UX based on the response to the emotional design questionnaire and the user's chronotype.

In some implementations, the customized display and UX may be implemented on the client device by an application-level operating system installed on the client device. The application-level operating system may include a device module that communicates with a native operating system of the client device. The application-level operating system may include an application module that communicates with a plurality of applications installed on the client device. The application-level operating system may include a UX module that generates a UX based on device data communicated from the native operating system to the application-level operating system and/or from application data communicated from the plurality of applications. The application-level operating system may include a display module that generates a UI on the device based on the UX. The application-level operating system may receive, process, and display data from the device module and/or the application module according to the customized display and UX.

FIG. 5 is a flowchart that further describes the method of generating a customized display and UX from FIG. 4, according to some implementations of the present disclosure. At 510, the method may include receiving one or more inputs. The one or more inputs may be received via the UI. At 520, the method may include generating use data that describes how the client device is used, or how the customized display or UX is interacted with. The use data may be generated by the client device and/or the local AI engine. At 530, the method may include updating the customized display and UX based on the use data. The customized display and UX may be updated by the local AI engine. The local AI engine may be trained to update the customized display and UX based on the use data.

In some implementations, at 540, the method may include transmitting the response, the user chronotype, the customized display and UX, the use data, and the updated customized display and UX to a server device via the client device. The server device may include a global AI engine that determines a set of initial user chronotypes. The global AI engine may be trained based on the user chronotype, the customized display and UX, the use data, and the updated customized display and UX.

As an example, the local AI engine may be implemented on a user device such as a smartphone. The user may access an emotional design questionnaire via the smartphone. For example, data associated with the emotional design questionnaire may be downloaded to the smartphone and/or displayed on the smartphone via an application. The application may be, for example, a UX application. The application may be an application-level operating system. The application may be a web browser application. In some implementations the user may access the emotional design questionnaire on another device such as a personal computer. The user may use the smartphone and or the personal computer to respond to the emotional design questionnaire. In some implementations the user's response to the emotional design questionnaire may be received via a user interface of the smartphone.

The user's response may be stored in the smartphone as response data. The response data may be provided to the local AI engine, which may determine the user chronotype based on the response data. The AI engine may then, based on the user chronotype, generate A customized display and UX that is specific to the user. The customized display and UX may be implemented on the smartphone. The customized display and UX may be implemented by, for example, an application-level operating system.

The user may begin interacting with the customized display and UX. For example, the user may provide one or more inputs which are received by the smartphone. The inputs may be selecting an application, performing various tasks on the device, creating various settings, making changes to the customized display and UX, and so forth. As the device receives these inputs the local AI engine may generate use data indicative of how the smartphone is used or how the customized display in UX is interacted with. Based on the use data, the local AI engine may update the customized display and UX to be more closely aligned with how the user interacts with the customized display and UX.

Various data may be provided from the smartphone to a server device. The server device may be a cloud server that communicates with a plurality of client devices to receive and send data related to customized displays and UXs for the plurality of client devices. A global AI engine may be implemented on the server device. The data provided from the smartphone to the cloud server may include the user's response to the emotional design questionnaire, data indicative of the customized display and UX implemented on the smartphone, the use data, and or data indicative of the updated customized display and UX. The data provided to the server device may be used to train the global AI engine to more accurately generate initial displays and UXs.

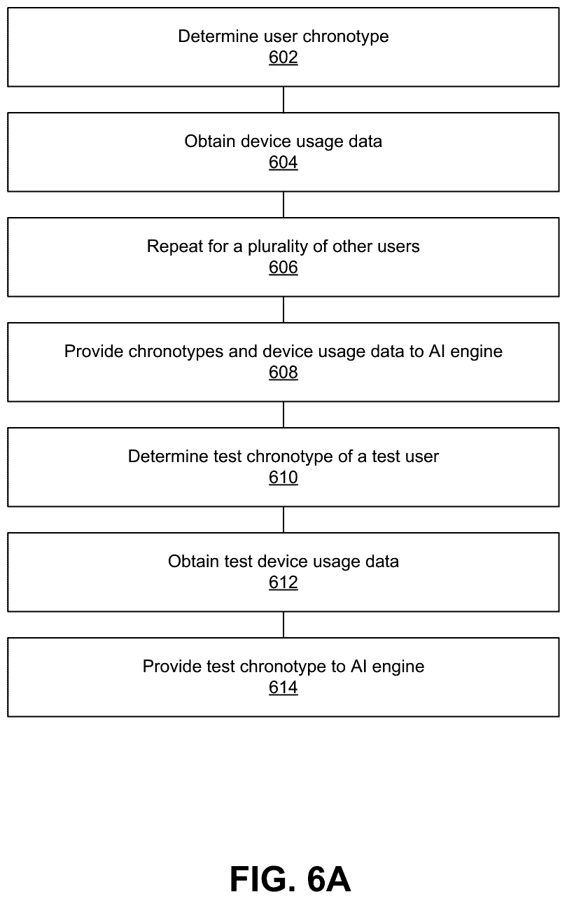

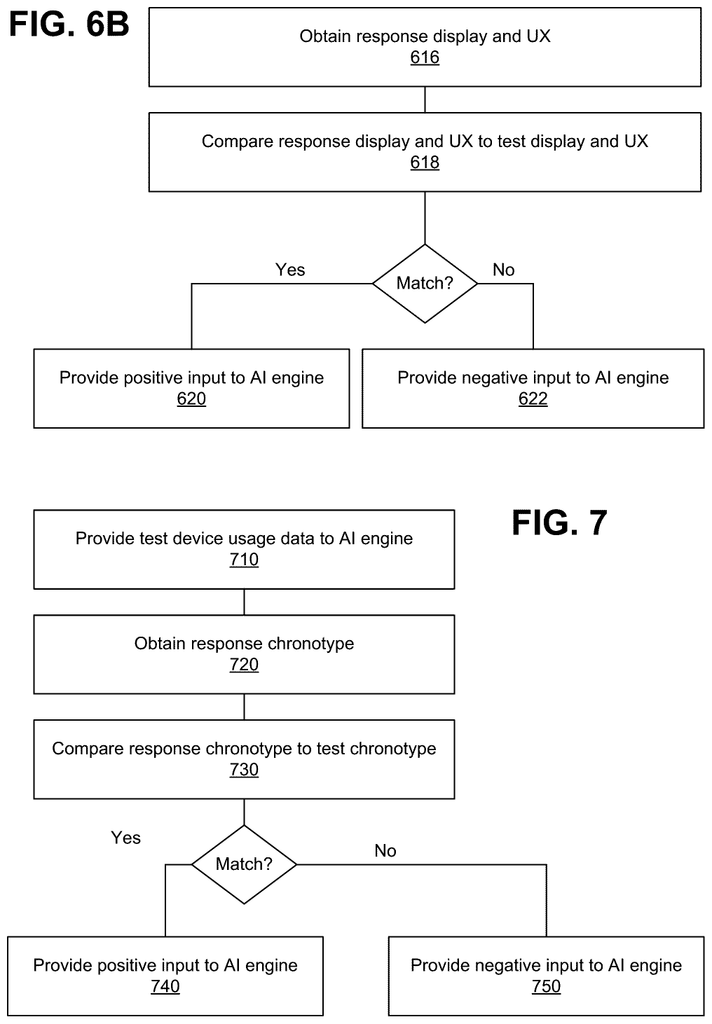

FIGS. 6A to 6B are flowcharts that describe a method of training an AI engine, according to some implementations of the present disclosure. In some implementations, at 602, the method may include determining a chronotype of a user associated with a device using an emotional design questionnaire. At 604, the method may include obtaining device usage data from the device associated with the first user. At 606, the method may include repeating the previous two steps for a plurality of other users and their associated devices. At 608, the method may include providing the plurality of chronotypes and the plurality of device usage data to the AI engine.

In some implementations, at 610, the method may include determining a test chronotype of a test user associated with a test device using the emotional design questionnaire. At 612, the method may include obtaining test device usage data from the test device. The usage data may be indicative of a test display and UX associated with the test device. The test display and UX may be designed by the user or may otherwise be confirmed to be preferred and/or optimal for the user. For example, a set of test displays and UXs may be provided to the user and the user may select which display and UX the user prefers. As another example, the user may be prompted to design their own display and UX.

At 614, the method may include providing the test chronotype to the AI engine. At 616, the method may include, in response to providing the test chronotype to the AI engine, obtaining a response display and UX from the AI engine. In some implementations, at 618, the method may include comparing the response display and UX to the test display and UX. At 620, the method may include, in response to the response display and UX matching the test display and UX, providing a positive input to the AI engine. At 622, the method may include, in response to the response display and UX not matching the test display and UX, providing a negative input to the AI engine.

In some implementations, the device usage data may indicate a display and UX associated with the device. A plurality of chronotypes may be determined and a plurality of device usage data may be obtained. The test device usage data may indicate a test display and UX associated with the test device. The positive input may indicate the response display and UX may be correct. The negative input may indicate the response display and UX may be incorrect.

In some implementations, the positive input may further indicate which portions of the response display and UX may match the test display and UX. In some implementations, the negative input may further indicate which portions of the response display and UX may not match the test display and UX. In some implementations, the device usage data may provide information about one or more applications installed on the device. In some implementations, the response display and UX may include one or more recommendations of specific applications. In some implementations, the device usage data may indicate settings on the device. The settings may include one or more of a notification setting, a display setting, a privacy setting, and an application-specific setting.

FIG. 7 is a flowchart that further describes the method of training an artificial intelligence from FIG. 6A, according to some implementations of the present disclosure. In some implementations, at 710, the method may include providing the test device usage data to the AI engine. At 720, the method may include, in response to providing the test device usage data to the AI engine, obtaining a response chronotype from the AI engine. At 730, the method may include comparing the response chronotype to the test chronotype. At 740, the method may include, in response to the response chronotype matching the test chronotype, providing a positive input to the AI engine. At 750, the method may include, in response to the response chronotype not matching the test chronotype, providing a negative input to the AI engine. The positive input may indicate the response chronotype may be correct. The negative input may indicate the response chronotype may be incorrect.

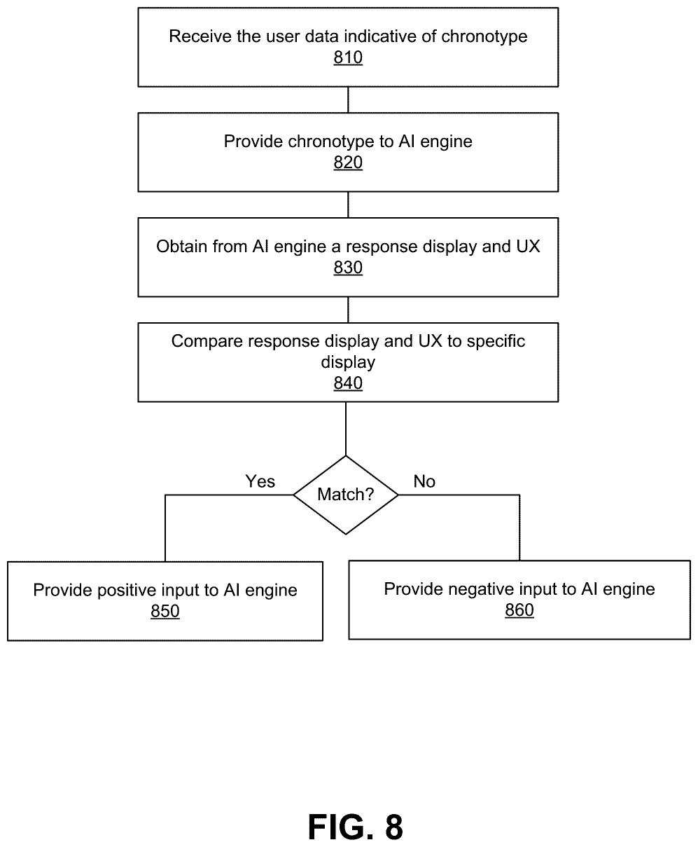

FIG. 8 is a flowchart that describes a method of training an AI engine, according to some implementations of the present disclosure. In some implementations, at 810, the method may include receiving the user data at a server device. In some implementations, the user data may indicate a specific display and UX implemented on a client device associated with the user data. The user data may further indicate a chronotype of a user associated with the client device. At 820, the method may include providing the chronotype to an AI engine, which may be implemented on the server device. For example, a portion of the user data indicative of the chronotype may be provided to the AI engine.

At 830, the method may include, in response to providing the chronotype to the AI engine, obtaining from the AI engine a response display and UX. At 840, the method may include comparing the response display and UX to the specific display and UX indicated by the user data. At 850, the method may include, in response to the response display and UX matching the specific display and UX, providing a positive input to the AI engine. The positive input may indicate the response display and UX is correct. At 860, the method may include, in response to the response display and UX not matching the specific display and UX, providing a negative input to the AI engine. The negative input may indicate the response display and UX is incorrect.

In some implementations, the AI engine may determine the response display and UX match the specific display and UX in response to a threshold number of features in the response display and UX matching corresponding features in the specific display and UX. In some implementations, the AI engine may determine the response display and UX does not match the specific display and UX in response to a threshold number of features in the response display and UX not matching corresponding features in the specific display and UX. In some implementations, the user data may provide information about one or more applications installed on the user device. The response display and UX may comprise one or more recommendations of specific applications. In some implementations, the user data may indicate one or more of a notification setting, a display setting, a privacy setting, and an application-specific setting.

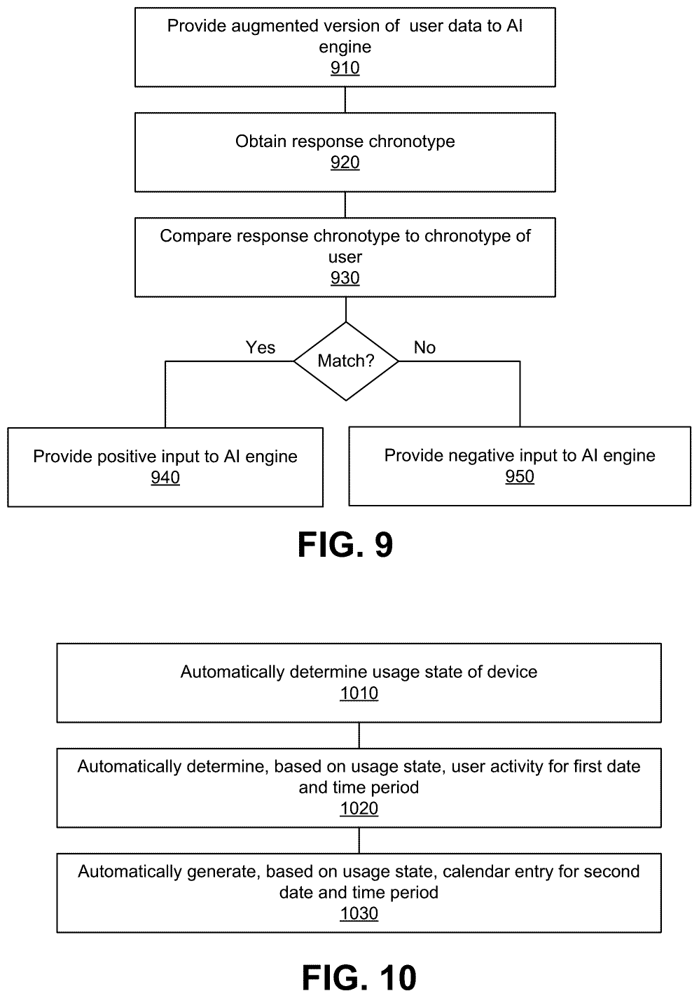

FIG. 9 is a flowchart that further describes the method of training an AI engine from FIG. 8, according to some implementations of the present disclosure. In some implementations, the method may include, at 910 providing an augmented version of the user data to the AI engine. The augmented version of the user data may omit the chronotype of the user. At 920, the method may include obtaining a response chronotype from the AI engine in response to providing the augment user data. The method may include, at block 930, comparing the response chronotype to the chronotype of the user indicated in the original user data. In response to the response chronotype matching the user chronotype, the method may include providing a positive input to the AI engine at 940. The positive input may indicate the response chronotype may be correct. In response to the response chronotype not matching the user chronotype, the method may include, at 950, providing a negative input to the AI engine. The negative input may indicate the response chronotype may be incorrect.

FIG. 10 is a flowchart that describes a method of automatically generating a calendar entry, according to some implementations of the present disclosure. In some implementations, at 1010, the method may include automatically determining a usage state of an application on a device for a first date and time period. The method may include, at 1020, determining a user activity for the first date and time period based on the usage state. At 1030, the method may include automatically generating, based on the usage state, a calendar entry for a second date and time period similar to the first date and time period of the user activity. The calendar entry may include data indicative of an activity name and a duration.

In some implementations, the method may be implemented by an application-level operating system of the device. The application-level operating system may include a device module that communicates with a native operating system of the device. The application-level operating system may include an application module that communicates with the application. The application-level operating system may include a UX module that generates a UX based on device data communicated from the native operating system to the application-level operating system and application data communicated from the application. The application-level operating system may include a display module that generates a user interface on the device based on the UX.

In some implementations, the method may include displaying the calendar entry on the device via a calendar application on the device. The calendar application may be implemented according to a customized display and UX for the device. The customized display and UX may be based on a chronotype of a user associated with the device.

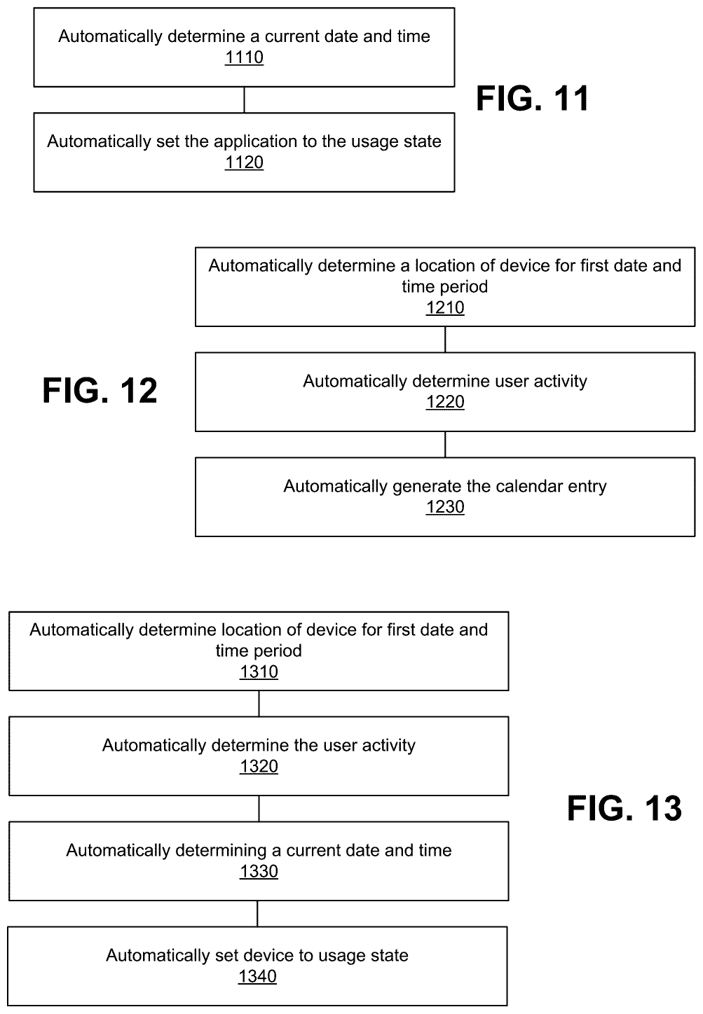

FIG. 11 is a flowchart that further describes the method of automatically generating a calendar entry from FIG. 10, according to some implementations of the present disclosure. In some implementations, at 1110, the method may include automatically determining a current date and time. At 1120, the method may include, in response to the current date and time matching the calendar entry, automatically setting the application to the usage state.

FIG. 12 is a flowchart that further describes the method of automatically generating a calendar entry from FIG. 10, according to some implementations of the present disclosure. In some implementations, at 1210, the method may include automatically determining a location of the device for the first date and time period. At 1220, the method may include automatically determining the user activity further based on the location. In some implementations, at 1230, the method may include automatically generating the calendar entry further based on the location.

FIG. 13 is a flowchart that further describes the method of automatically generating a calendar entry from FIG. 10, according to some implementations of the present disclosure. In some implementations, at 1310, the method may include automatically determining a location of the device for the first date and time period. At 1320, the method may include automatically determining the user activity further based on the location. At 1330, the method may include automatically determining a current date and time and a current location. In response to the current date and time matching the calendar entry, and further in response to the current location matching the location of the client device for the first date and time period, the method may include automatically setting the application to the usage state at 1340.

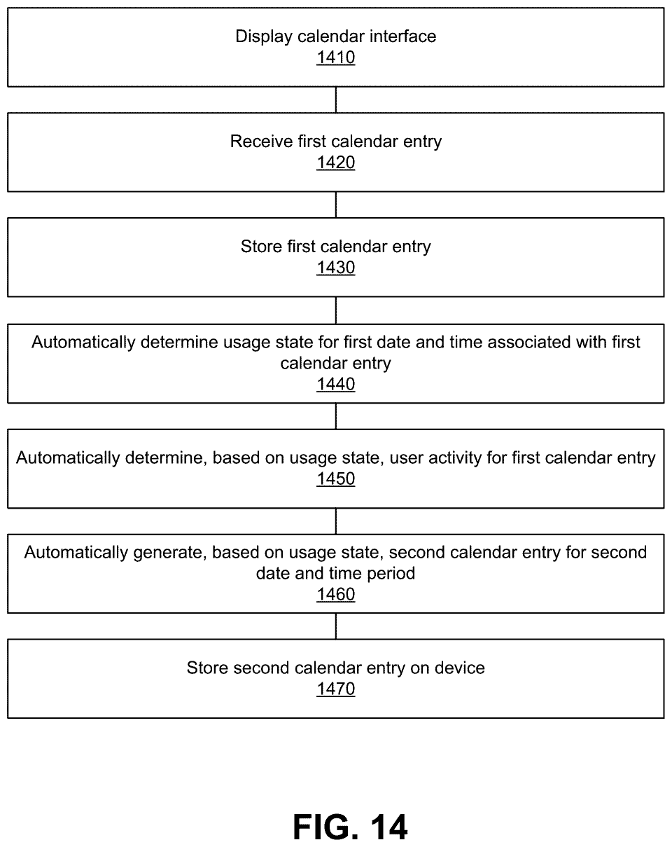

FIG. 14 is a flowchart that describes a method of generating a composite calendar based on a scheduled activity and an unscheduled activity, according to some implementations of the present disclosure. In some implementations, at 1410, the method may include displaying a calendar interface associated with a calendar module. The calendar interface may be displayed via a UI of a device. The calendar application may generate the calendar interface on the UI. The calendar module may be implemented on the device. At 1420, the method may include receiving, via the calendar interface, an input corresponding to a first calendar entry. At 1430, the method may include storing the first calendar entry on the device. At 1440, the method may include automatically determining a usage state of the device for a first date and time period associated with the first calendar entry. The determination may be made by the device. At 1450, the method may include automatically determining, based on the usage state, a user activity for the calendar entry. The usage state may be determined for the first date and time period associated with the first calendar entry. At 1460, the method may include automatically generating, based on the usage state, a second calendar entry for a second date and time period similar to the first date and time period of the user activity. At 1470, the method may include storing the second calendar entry on the device. The calendar interface may show the first calendar entry after the first calendar entry is made. The calendar interface may show the second calendar entry after the second calendar entry is made.

In some implementations, the first calendar entry may comprise an event location. The method may include automatically determining, by the device, a current date and time and/or a current location of the device. In response to the current date and time and/or the current location matching the first calendar entry, the method may include automatically setting the device to the usage state for the first calendar entry.

In some implementations, the method may be implemented by an application-level operating system of the device. The application-level operating system may include a device module, an application module, a UX module, and/or a display module. In some implementations, the calendar module may be implemented on the device according to a customized display and UX. The customized display and UX may be based on a chronotype of a user associated with the device.

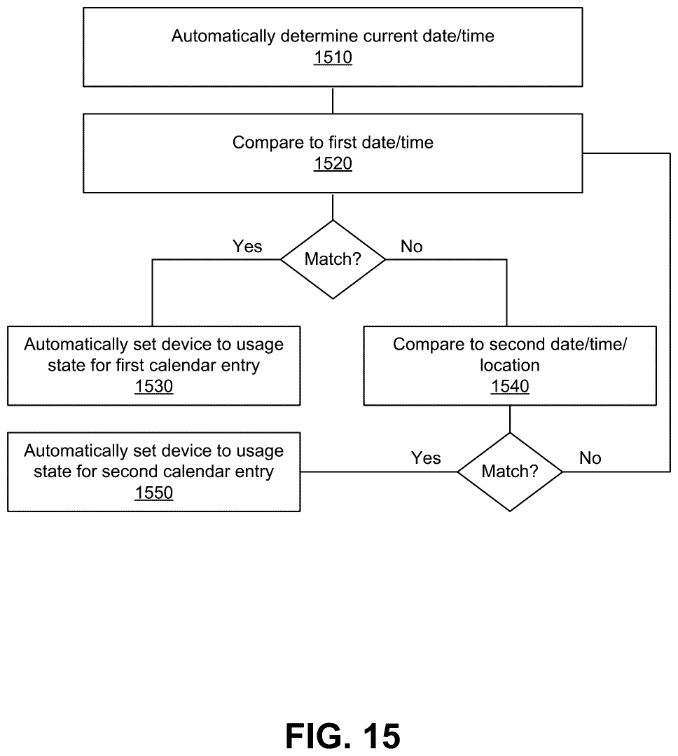

FIG. 15 is a flowchart that further describes the method of generating a composite calendar from FIG. 14, according to some implementations of the present disclosure. In some implementations, the first calendar entry may include a first device usage entry that indicates the usage state of the device for the first calendar entry. The second calendar entry may include a second device usage entry that indicates the usage state of the device for the second calendar entry. In some implementations, at 1510, the method may include, automatically determining, by the device, a current date and time. At 1520, the method may include comparing the current date and time to the first date and time period associated with the calendar entry.

In response to the current date and time matching the first calendar entry, the method may include, at block 1530, automatically setting the device to the usage state for the first calendar entry. At 1540, the method may include comparing the current date and time to the second calendar entry. This may be done in response to the current date and time not matching the first calendar entry. Alternatively, checking whether the current date and time match either the first calendar or the second calendar may be done by any of a variety of methods, such as using the current date and time as search parameters and searching calendar entry data for matches. At block 1550, in response to the current date and time matching the second calendar entry, the method may include automatically setting the device to the usage state for the second calendar entry.

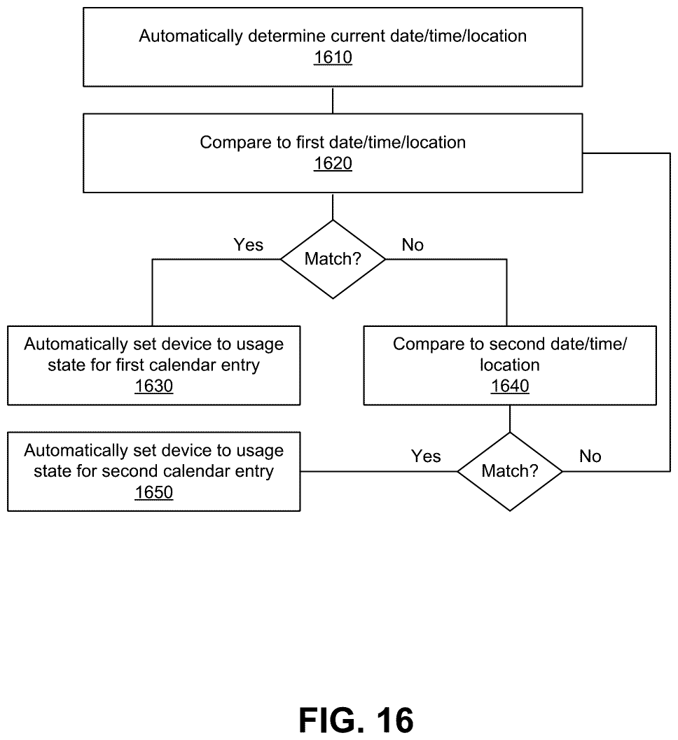

FIG. 16 is a flowchart that further describes the method of generating a composite calendar from FIG. 14, according to some implementations of the present disclosure. In some implementations, the first calendar entry may include a first device usage entry that indicates the usage state of the device for the first calendar entry. The second calendar entry may include a second device usage entry that indicates the usage state of the device for the second calendar entry. In some implementations, at 1610, the method may include automatically determining a current date and time and/or a current location of the device for the first date and time period. At 1620, the method may include comparing the current date, time, and location to the first calendar entry. In response to the current date, time, and location matching the first calendar entry, the method may include, at 1630, automatically setting the device to the usage state for the first calendar entry. Alternatively, the method may include automatically searching calendar entry data using the current date, time, and location as search parameters. At 1640, the method may include comparing the current date, time, and location to the second calendar entry. In response to the current date, time, and location matching the second calendar entry, the method may include automatically setting the device to the usage state for the second calendar entry at block 1650.

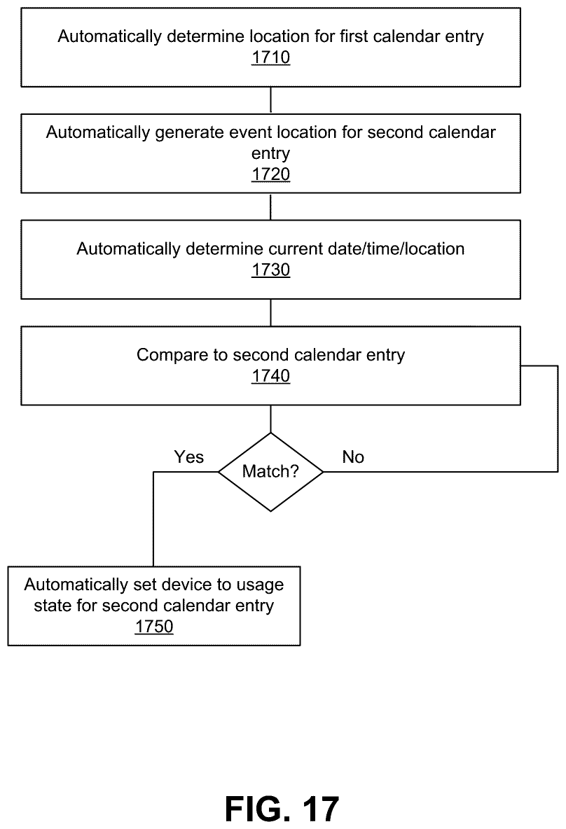

FIG. 17 is a flowchart that describes a method of automatically generating a calendar entry, according to some implementations of the present disclosure. In some implementations, at 1710, the method may include automatically determining a location for the first calendar entry. At 1720, the method may include automatically generating an event location for the second calendar entry. Generating the second calendar entry as described above may include generating an event location that matches the location of the device for the first date and time period. For example, at the first date and time, the device may automatically determine its location and update the second calendar entry with the location.

At 1730, the method may include automatically determining a current date, time, and/or location of the device. The method may include, at 1740, comparing the current date, time, and/or location to the second calendar entry. For example, the method may include using the current date, time, and/or location as search parameters. In response to the current date, time, and/or location matching the second calendar entry, the method may include automatically setting the device to the usage state associated with the second calendar entry at 1750.

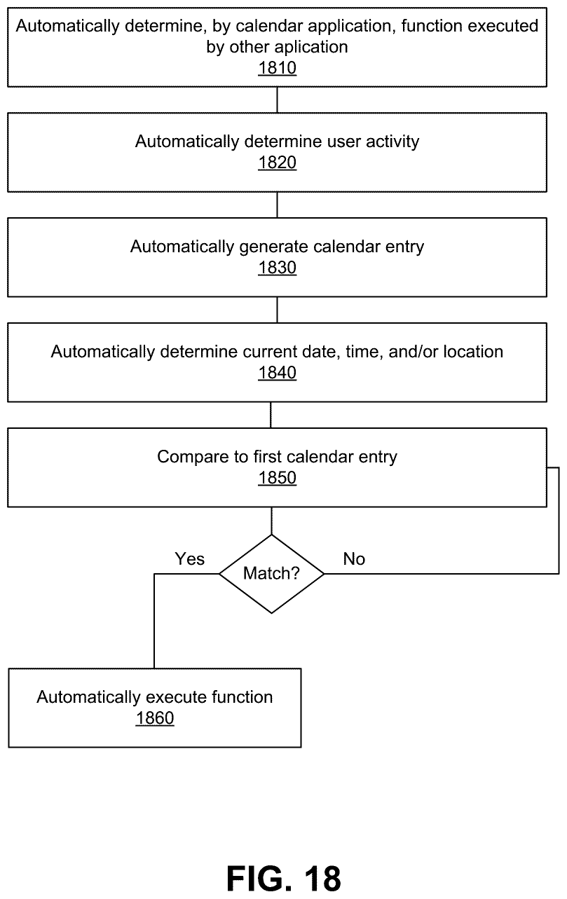

FIG. 18 is a flowchart that describes a method of automatically generating a calendar entry based on a function executed in another application on a device, according to some implementations of the present disclosure. In some implementations, at 1810, the method may include automatically determining, by a calendar application implemented on the device, a function executed by the other application on the device. The calendar entry may comprise an activity name and a duration. The calendar application may have permissions to read data associated with the other application, create new data in the other application, provide inputs to the other application, and receive outputs from the other application. For example, the calendar application may determine a user opens a health application and records a workout. The other application may include one or more of a communication application, a health application, a finance application, and a task application. The calendar application may, in some implementations, be implemented on the device according to a customized display and UX based on a chronotype of a user associated with the device.

In various implementations, the method may include, at 1820, automatically determining, by the calendar application, a user activity for a first date and time period associated with the function. At 1830, the method may include automatically generating, based on the user activity, a calendar entry for a second date and time period similar to the first date and time period. In some implementations, the calendar entry may include an activity name and/or duration.

The method may include, at 1840, automatically determining, by the calendar application, a current date, time, and/or location of the device. In some implementations, generating the calendar entry may include generating an event location that matches the location of the device for the first date and time period. At 1850, the current date, time, and/or location may be compared to the calendar entry. In response to the current date, time, and/or location matching the calendar entry, the method may include, at 1860, automatically executing the function by the other application. For example, the calendar entry may correspond to a function by a messaging application. The calendar application may automatically send instructions to the messaging application to execute the function associated with the calendar entry. The messaging application may, in response to receiving the instructions, execute the function.

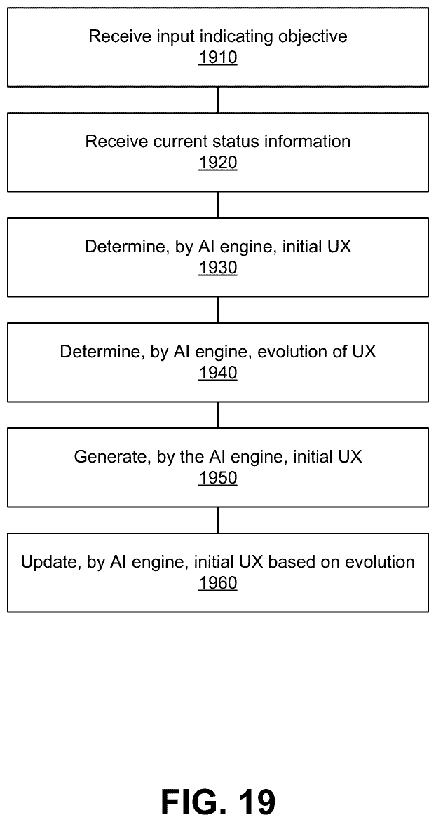

FIG. 19 is a flowchart that describes a method of generating an objective-oriented UX, according to some implementations of the present disclosure. In some implementations, at 1910, the method may include receiving, at a client device, an input indicating an objective of a user. The objective may be related to a personal goal or a lifestyle goal of the user. At 1920, the method may include receiving, at the client device, information about the user associated with a current status of the user relative to the objective. At 1930, the method may include determining, by an AI engine associated with the client device, an initial UX for the client device based on the objective and the current status. The AI engine may be trained to determine the initial UX based on the objective and the current status. At 1940, the method may include determining, by the AI engine, an evolution of the UX based on the objective and the current status. The AI engine may be trained to determine the evolution of the UX based on the objective and the current status. At 1950, the method may include generating, by the AI engine, the initial UX. At 1960, the method may include updating, by the AI engine, the initial UX according to the evolution of the UX.

In some implementations, the initial UX may be implemented on the client device by an application-level operating system. The application-level operating system may include a device module, an application module, a UX module, and/or a display module. The initial UX may be implemented based at least in part on device data communicated from the native operating system to the application-level operating system and application data communicated from one or more of a plurality of applications.

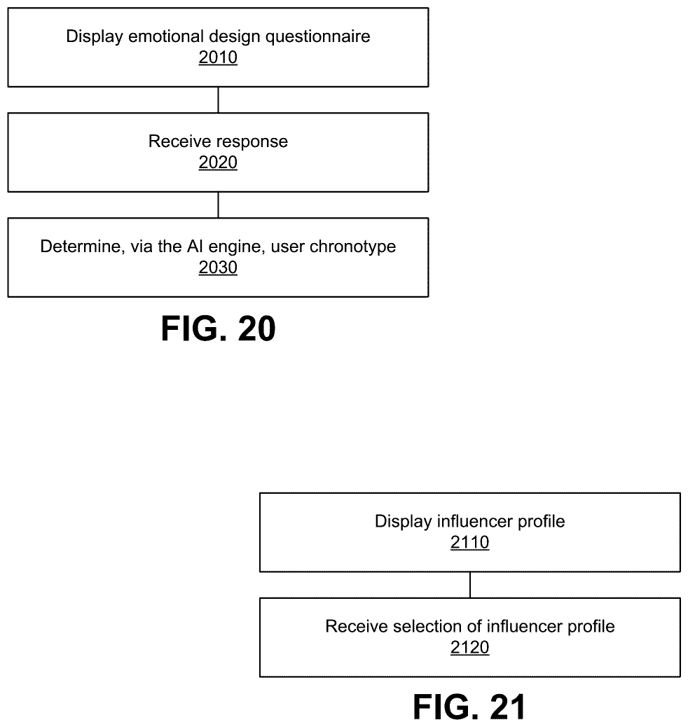

FIG. 20 is a flowchart that further describes the method of generating an objective-oriented user experience from FIG. 19, according to some implementations of the present disclosure. In some implementations, the initial UX and/or the evolution of the UX may be based at least in part on a user chronotype. Generating the initial UX may include, at 2010, displaying, via a UI of the client device, an emotional design questionnaire. The AI engine may be trained to determine a user chronotype based on a response to the emotional design questionnaire and/or to generate the initial UX based at least in part on the user chronotype. At 2020, the method may include receiving the response, such as via the UI. The method may include, at 2030, determining, via the AI engine, the user chronotype based on the response. The initial UX may be generated (e.g., at 1950) based at least in part on the objective, the current status, and/or the user chronotype.

FIG. 21 is a flowchart that further describes the method of generating an objective-oriented user experience from FIG. 19, according to some implementations of the present disclosure. In some implementations, the initial UX and/or the evolution of the UX may be based at least in part on an influencer profile. The method may include, at 2110, displaying, via the UI, an influencer profile associated with influencer profile data stored on the client device or a server device associated with the client device. The influencer profile data may comprise information about an influencer's lifestyle. The influencer profile data may be associated with influencer UX data for a customized UX used by the influencer. At 2120, the method may include receiving, via the UI, a selection indicating the personal goal or lifestyle goal of the user may be associated with the influencer's lifestyle. In response to receiving the selection, the initial UX may be generated further based on the influencer UX data, e.g., at 1950.

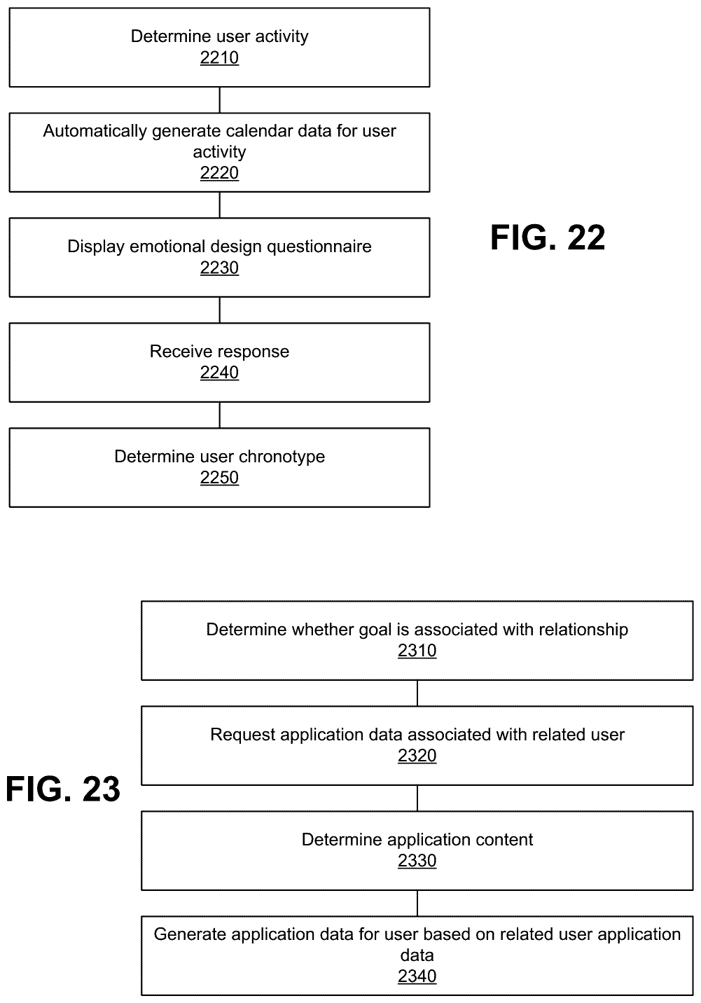

FIG. 22 is a flowchart that further describes the method of generating an objective-oriented user experience from FIG. 19, according to some implementations of the present disclosure. In some implementations, at 2210, the method may include determining, by the AI engine, a user activity associated with the personal goal or the lifestyle goal. At 2220, the method may include automatically generating, by the AI engine and in a calendar application associated with the client device, calendar data for a calendar event or task for the user activity. The AI engine may be trained to determine the user activity based on the personal goal or the lifestyle goal.

In some implementations, at 2230, the method may include displaying, via a UI of the client device, an emotional design questionnaire. At 2240, the method may include receiving the response via the UI. At 2250, the method may include determining, via the AI engine, the user chronotype based on the response. The AI engine may be trained to determine the user chronotype based on the response to the emotional design questionnaire and to generate the calendar data based on the user chronotype. The calendar data may be generated based at least in part on the user chronotype, e.g., at 2220.

FIG. 23 is a flowchart that further describes the method of generating an objective-oriented user experience from FIG. 19, according to some implementations of the present disclosure. In some implementations, at 2310, the method may include determining, by the AI engine, whether the personal goal or the lifestyle goal may be associated with a relationship between the user and a second user. The AI engine may be trained to determine whether the personal goal or the lifestyle goal is associated with the relationship. For example, the personal goal may include improving the relationship with the second user. At 2320, the method may include, in response determining the personal goal or the lifestyle goal may be associated with the relationship, requesting from a server device associated with the client device, first application data that indicates how the related user has used a first instance of an application. The first instance may be installed on a second client device associated with the related user. The first instance may be installed on the server device. The request may be made directly from the client device to the second client device. The request may be made from the client device to the server device, which in turn may request the first application data from the second client device.

At 2330, the method may include determining application content by the AI engine based on the first application data. The application content may enable the user to improve or reinforce the relationship with the related user. The AI engine may be trained to determine the application content based on an activity of the related user, the activity indicated by the first application data. At 2340, the method may include generating, by the AI engine, second application data based on the application content determined by the AI engine. The second application data may correspond to a second instance of the application, the second instance installed on the client device associated with the user. The second application data may correspond to a different application installed on the client device associated with the user.

As a specific example of the foregoing, the user may have a goal of connecting more with specific colleagues to develop professional relationships. A colleague of the user may have an instance of a professional networking application installed on their device. The user's device may request, from the colleague's device or a server associated with the professional networking application, data associated with the colleague's activity on the platform. The AI engine may use the data associated with the colleague's activity, in association with data related to the user's goal, to generate application content for the user's device. For example, the AI engine may determine when the colleague is most active on the platform. The application content may, for example, be associated with a calendar application on the user's device, showing when the colleague is most likely to be active on the platform.

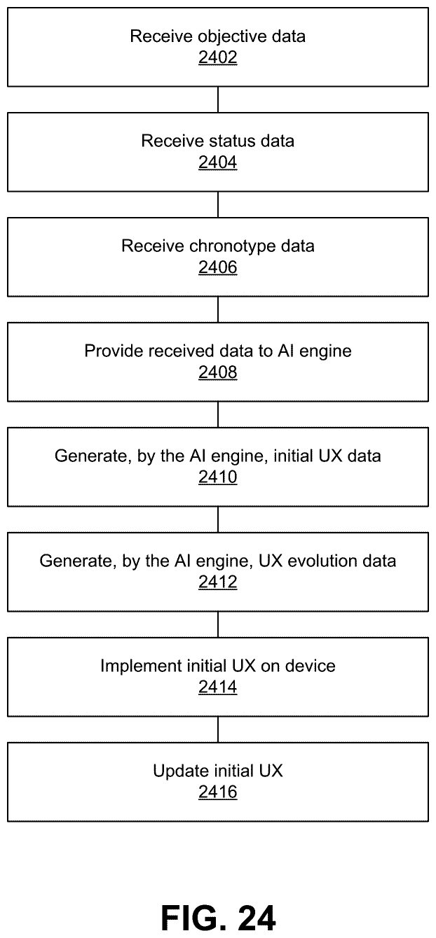

FIG. 24 is a flowchart that describes a method of generating an objective-oriented user experience, according to some implementations of the present disclosure. In some implementations, at 2402, the method may include receiving objective data indicating an objective of a user. The objective may be related to a personal goal or a lifestyle goal of the user. At 2404, the method may include receiving status data indicating a current status of the user relative to the objective. At 2406, the method may include receiving chronotype data indicating a chronotype of the user. At 2408, the method may include providing the objective data, the status data, and/or the chronotype data to an AI engine. At 2410, the method may include generating, by the AI engine, initial UX data. The AI engine may be trained to generate the initial UX data based on the objective data, the status data, and/or the chronotype data. At 2412, the method may include generating, by the AI engine, UX evolution data. The AI engine may be trained to generate UX evolution data based on the initial UX data, the objective data, the status data, and/or the chronotype data. At 2414, the method may include implementing the initial UX on a device associated with the user based on the initial UX data. At 2416, the method may include updating the initial UX according to the UX evolution data.

In some implementations, the chronotype data may be generated by the AI engine in response to a response by the user to an emotional design questionnaire. The AI engine may be trained to determine the user chronotype based on the response to the emotional design questionnaire. In some implementations, the initial UX may be implemented on the client device via an application-level operating system. The application-level operating system may include a device module, an application module, a UX module, and/or a display module.

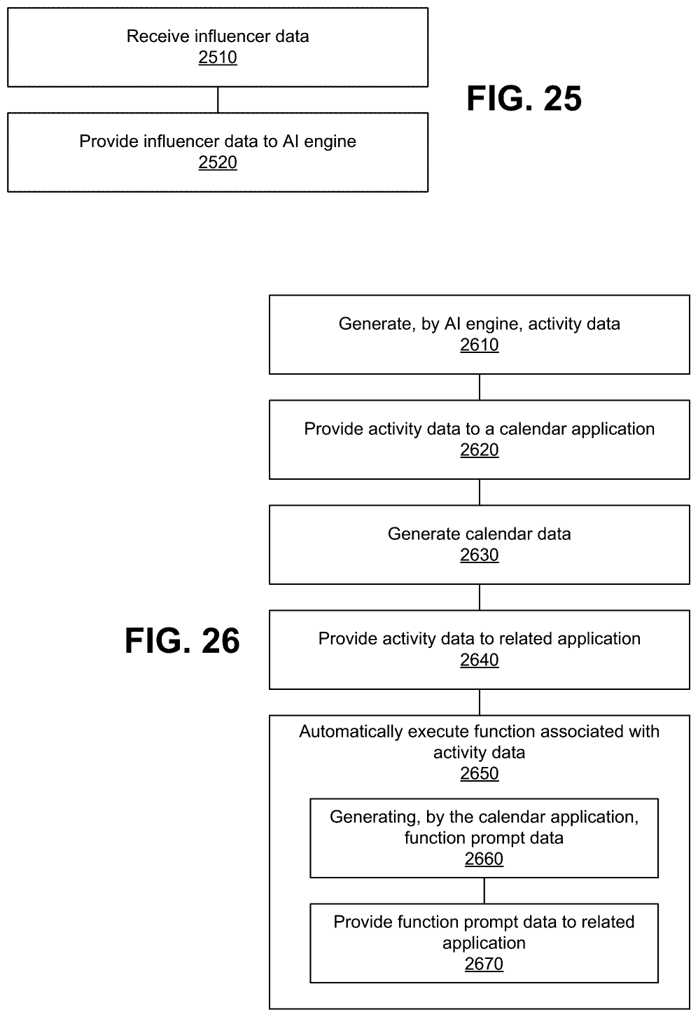

FIG. 25 is a flowchart that further describes the method of generating an objective-oriented user experience from FIG. 24, according to some implementations of the present disclosure. In some implementations, at 2510, the method may include receiving influencer data corresponding to an influencer lifestyle. At 2520, the method may include providing the influencer data to the AI engine. The AI engine may be trained to generate the initial UX data or the UX evolution data based at least in part on the influencer data. Generating the initial UX data or the UX evolution data may be based at least in part on the influencer data, e.g., at 2412.

FIG. 26 is a flowchart that further describes the method of generating an objective-oriented user experience from FIG. 24, according to some implementations of the present disclosure. In some implementations, at 2610, the method may include generating, by the AI engine, activity data associated with the personal goal or the lifestyle goal. At 2620, the method may include providing the activity data to a calendar application. At 2630, the method may include generating calendar data indicating a scheduled calendar event or task for the user activity. The activity data may indicate a user activity for helping the user accomplish the objective. The AI engine may be trained to generate the activity data based on one or more of the objective data, the status data, and the chronotype data.

In some implementations, at 2640, the method may include providing the activity data to a related application. The related application may be related to the user activity. At 2650, the method may include, in response to a current date or time matching the calendar data, automatically executing a function by the related application based on the activity data. In some implementations, automatically executing the function may include, at 2660, generating, by the calendar application, function prompt data. The function prompt data may prompt the related application to execute the function. At 2670, the method may include providing the function prompt data from the calendar application to the related application.

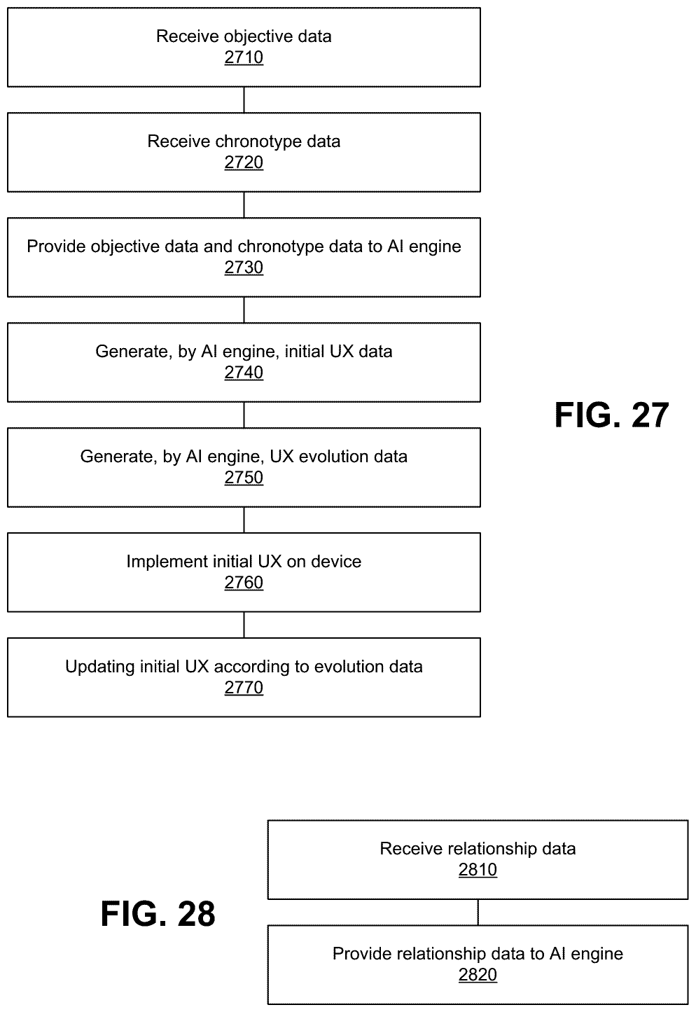

FIG. 27 is a flowchart that describes a method of generating an objective-oriented user experience, according to some implementations of the present disclosure. In some implementations, at 2710, the method may include receiving objective data indicating an objective of a user. The objective may be related to a personal goal or a lifestyle goal of the user. At 2720, the method may include receiving chronotype data indicating a chronotype of the user. At 2730, the method may include providing the objective data and the chronotype data to an AI engine. The AI engine may be trained to generate initial UX data based on the objective data and the chronotype data. At 2740, the method may include generating, by the AI engine, the initial UX data. The AI engine may be trained to generate UX evolution data based on the initial UX data, the objective data, and the chronotype data. At 2750, the method may include generating, by the AI engine, the UX evolution data. At 2760, the method may include implementing the initial UX on the client device based on the initial UX data. At 2770, the method may include updating the initial UX according to the UX evolution data.

In some implementations, the initial UX data may correspond to one or more functions executable by a calendar application. The one or more functions may be based at least in part on the chronotype data. In some implementations, the one or more functions may correspond to a user activity. The one or more functions may be executable by the calendar application to prompt, via a device on which the objective-oriented UX may be implemented, the user to engage in the user activity.

FIG. 28 is a flowchart that further describes the method of generating an objective-oriented user experience from FIG. 27, according to some implementations of the present disclosure. In some implementations, at 2810, the method may include receiving relationship data indicating a relationship of the user with another person. The relationship data may indicate a degree or a type of the relationship. At 2820, the method may include providing the relationship data to the AI engine. The AI engine may be trained to generate the initial UX data based at least in part on the relationship data, e.g., at 2740. In some implementations, the initial UX data may correspond to one or more functions executable by a device on which the objective-oriented UX may be implemented. The one or more functions may enhance the relationship.

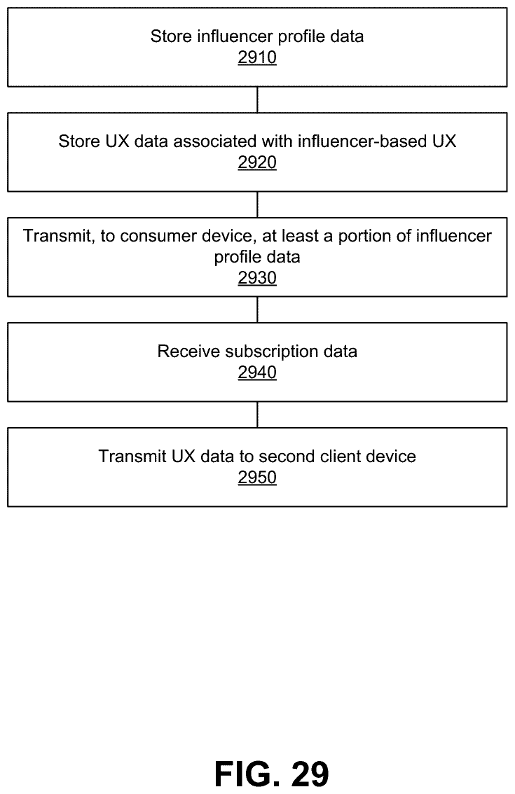

FIG. 29 is a flowchart that describes a method of implementing an influencer-based user experience, according to some implementations of the present disclosure. In some implementations, at 2910, the method may include storing influencer profile data on a server device. The influencer profile data may be associated with an influencer. At 2920, the method may include storing, on the server device, UX data associated with the influencer profile data. The UX data may be associated with an influencer-based UX. The influencer-based UX may be implemented on an influencer device associated with the influencer profile data. At 2930, the method may include transmitting, to a consumer device, at least a portion of the influencer profile data. The portion of the influencer profile data may be displayed on the consumer device with a subscription prompt that prompts a consumer to subscribe to the influencer-based UX. At 2940, the method may include receiving, at the server device and from the consumer device, subscription data indicating a subscription by the consumer to the influencer-based UX. At 2950, the method may include transmitting, to the second client device, the UX data. The influencer-based UX associated with the UX data may be implemented on the second client device.

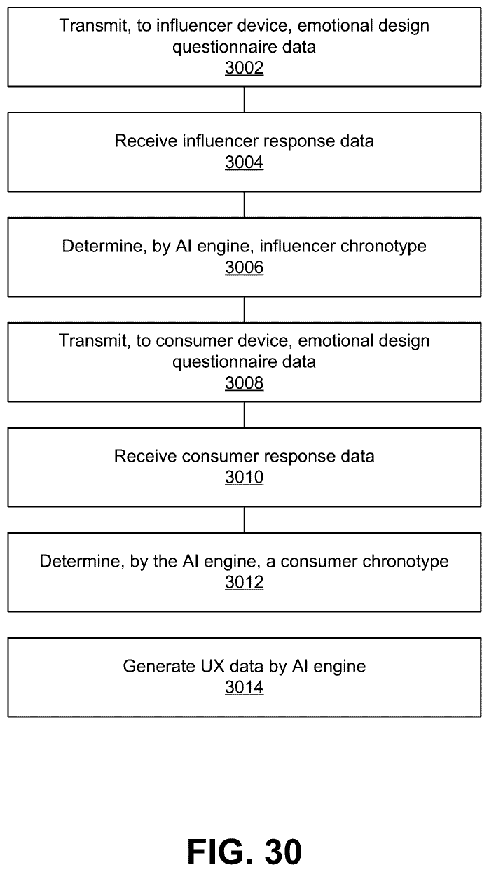

FIG. 30 is a flowchart that further describes the method of implementing an influencer-based user experience from FIG. 29, according to some implementations of the present disclosure. In some implementations, the AI engine may be trained to generate the UX data based on an influencer chronotype and/or a consumer chronotype. At 3002, the method may include transmitting, to the influencer device, emotional design questionnaire data. At 3004, the method may include receiving influencer response data from the influencer device. The AI engine may be trained to determine an influencer chronotype based on the influencer response data. At 3006, the method may include determining, by an AI engine, the influencer chronotype based on the influencer response data.

In some implementations, at 3008, the method may include transmitting, to the consumer device, the emotional design questionnaire data. At 3010, the method may include receiving consumer response data from the consumer device. The AI engine may be trained to determine a consumer chronotype based on the consumer response data. At 3012, the method may include determining, by the AI engine, the consumer chronotype based on the consumer response data. The AI engine may be trained to generate the UX data based on the influencer chronotype and/or the consumer chronotype. At 3014, the method may include generating, via the AI engine, the UX data.

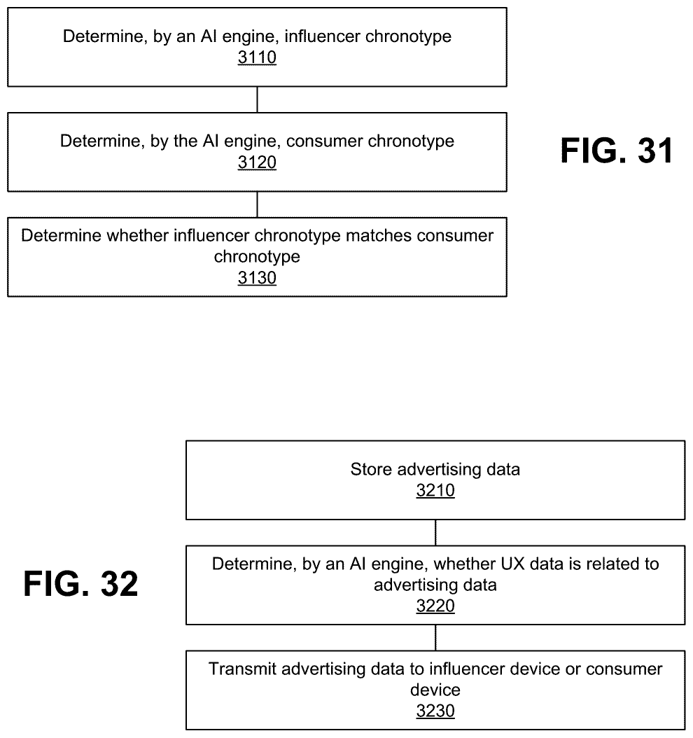

FIG. 31 is a flowchart that further describes the method of implementing an influencer-based user experience from FIG. 29, according to some implementations of the present disclosure. In some implementations, at 3110, the method may include determining, by an AI engine, an influencer chronotype based on influencer response data associated with an influencer response to an emotional design questionnaire. At 3120, the method may include determining, by the AI engine, a consumer chronotype based on consumer response data associated with a consumer response to the emotional design questionnaire. At 3130, the method may include determining whether the influencer chronotype matches the consumer chronotype. The influencer profile data may be transmitted to the consumer device in response to the influencer chronotype matching the consumer chronotype, e.g., at 2950.

FIG. 32 is a flowchart that further describes the method of implementing an influencer-based user experience from FIG. 29, according to some implementations of the present disclosure. In some implementations, at 3210, the method may include storing, at the server device, advertising data associated with a lifestyle-based advertisement. At 3220, the method may include determining, by an AI engine, whether the UX data is related to the advertising data. The UX data may indicate a lifestyle of the influencer or a lifestyle of the consumer. The AI engine may be trained to determine whether the UX data is related to the advertising data. For example, the influencer may be an influential author and the consumer may select the influencer's profile to base their UX on, e.g., at 2930 and 2940. The advertising data may be associated with one or more books, or may be associated with an advertisement for a writing course. The UX data may include data associated with a calendar application for one or more calendar entries associated with writing prompts for the consumer based on the influencer UX. At 3230, the method may include, in response to the UX data being related to the advertising data, transmitting the advertising data to the influencer device or the consumer device.

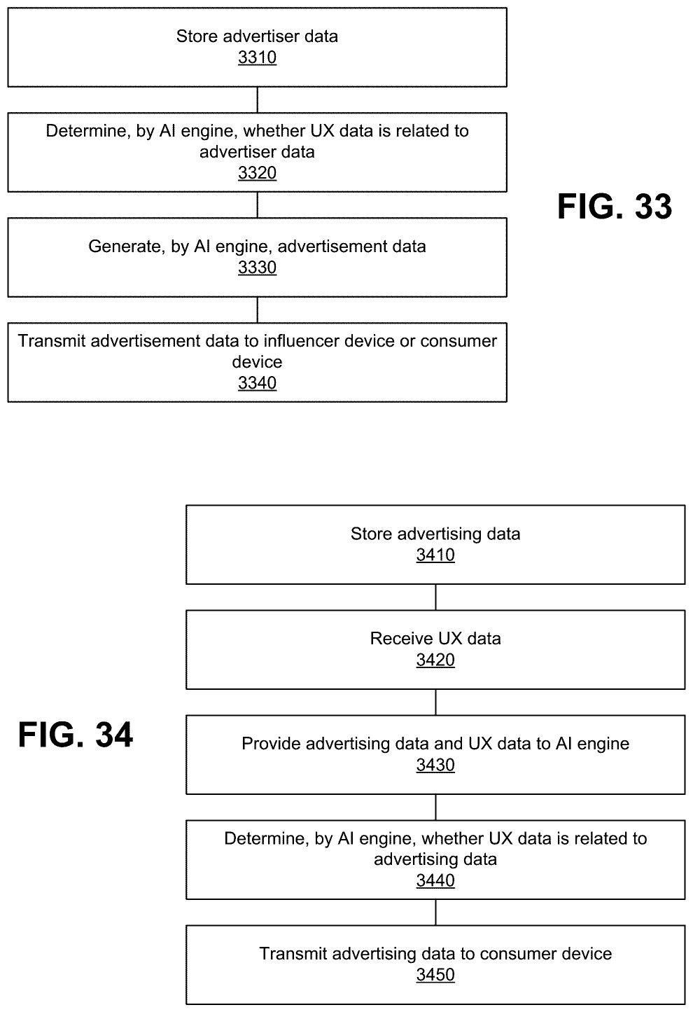

FIG. 33 is a flowchart that further describes the method of implementing an influencer-based user experience from FIG. 29, according to some implementations of the present disclosure. In some implementations, at 3310, the method may include storing, at the server device, advertiser data associated with a product or service of an advertiser. The advertiser data may correspond to an advertisement of the product or the service. At 3320, the method may include determining, by an AI engine, whether the UX data may be related to the advertiser data. At 3330, the method may include, in response to the UX data being related to the advertiser data, generating, by the AI engine, advertisement data. At 3340, the method may include transmitting the advertisement data to the influencer device or the consumer device. The advertisement may be customized for the influencer or the consumer based on the UX data.

As a specific example, the advertiser data may be associated with a business that brokers stock in publicly traded funds and companies. The influencer data may indicate the influencer follows and invests in stocks with certain risk profiles. The AI engine may generate advertisement data that describes the influencer's investing activity and recommends one or more of the advertiser's products. In some implementations, the advertiser data may be associated with the influencer, such as by indicating the influencer has approved their profile to be associated with the advertiser.

FIG. 34 is a flowchart that describes a method of generating a lifestyle-based advertisement, according to some implementations of the present disclosure. In some implementations, at 3410, the method may include storing advertising data associated with a lifestyle-based advertisement. At 3420, the method may include receiving UX data corresponding to a UX implemented on a consumer device. The UX may be indicative of a lifestyle of a consumer. At 3430, the method may include providing the advertising data and the UX data to an AI engine. The AI engine may be trained to determine whether the UX data may be related to the advertising data. At 3440, the method may include determining, by the AI engine, whether the UX data is related to the advertising data. At 3450, the method may include, in response to the UX data being related to the advertising data, transmitting the advertising data to the consumer device. The consumer device may use the advertising data to display the lifestyle-based advertisement to the consumer.

In some implementations, the UX may be based on a chronotype of the consumer. In some implementations, the UX may be based at least in part on an influencer UX. The advertising data may correspond to a product or service promoted by the influencer. In some implementations, the UX may include an objective-oriented UX. The AI engine may be trained to determine the advertising data is related to the UX data in response to determining a product or service associated with the advertising data may be related to an objective of the consumer indicated by the objective-oriented UX. In some implementations, the UX may be implemented on the consumer device by an application-level operating system. The application-level operating system may include a device module, an application module, a UX module, and/or a display module.

As a specific example of the method, the advertising data may be associated with an advertisement for a particular health practice such as a particular diet. The UX data may indicate a user associated with the UX has a goal of eating healthier. For example, the UX may include a widget that helps the user track their food intake, such as a widget associated with a food journal. The AI engine may determine the advertising data is associated with the UX based on the correlation of both with food intake. In response to determining the advertisement is relevant to the user's lifestyle, the advertising data may be transmitted to the user's device and used on the device to display the advertisement to the user.

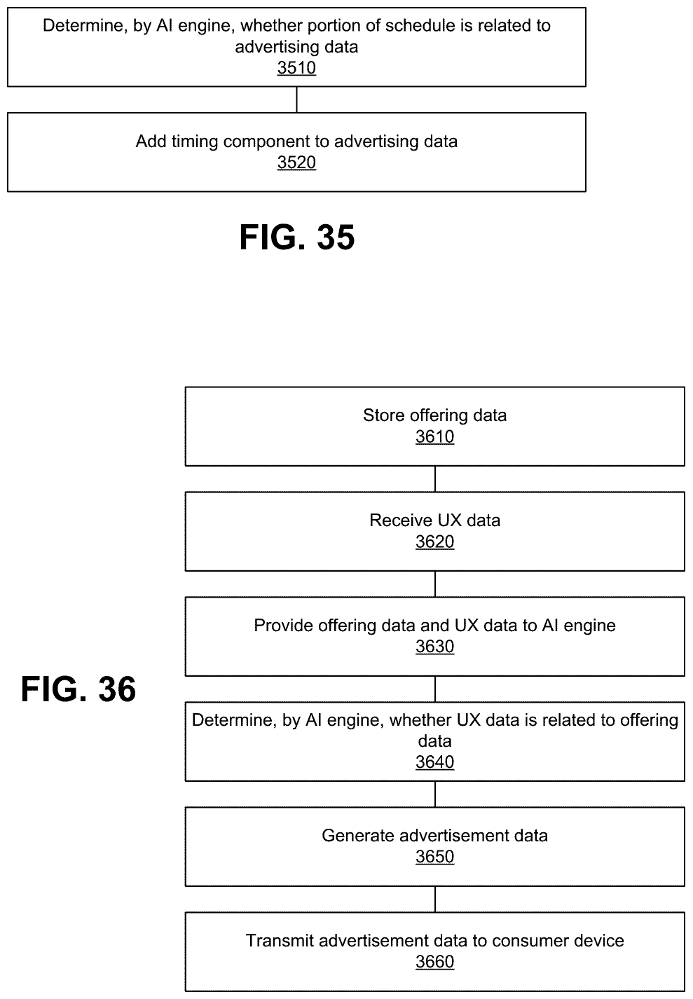

FIG. 35 is a flowchart that further describes the method of generating a lifestyle-based advertisement from FIG. 34, according to some implementations of the present disclosure. The method may also be applied in connection with the method of generating a lifestyle-based advertisement from FIG. 36, according to some implementations of the present disclosure. In some implementations, the UX data may indicate a schedule of the consumer. At 3510, the method may include determining, by the AI engine, whether a portion of the schedule may be related to the advertising data. At 3520, the method may include, in response to the portion of the schedule being related to the advertising data, adding to the advertising data a timing component. The consumer device may use the advertising data to display the lifestyle-based advertisement to the consumer according to the timing component of the advertising data.

In some implementations, the AI engine may be trained to determine the portion of the schedule may be related to the advertising data in response to determining the consumer may be likely to purchase a product or service associated with the advertising data during the portion of the schedule. For example, the UX data may indicate the user reviews their budget every Sunday morning. The advertising data may be associated with a coupon relevant to an aspect of the user's budget, such as for clothing. The AI engine may add a timing component to the advertising data so that the advertisement is displayed to the user on Sunday morning when they are reviewing their budget.

FIG. 36 is a flowchart that describes a method of generating a lifestyle-based advertisement, according to some implementations of the present disclosure. In some implementations, at 3610, the method may include storing offering data associated with a product or service. At 3620, the method may include receiving UX data that indicates a UX implemented on a consumer device. The UX may be indicative of a lifestyle of a consumer. At 3630, the method may include providing the offering data and the UX data to an AI engine. The AI engine may be trained to determine whether the UX data may be related to the offering data. The AI engine may be trained to generate advertisement data based on the UX data and the offering data. At 3640, the method may include determining, by the AI engine, whether the UX data is related to the offering data. At 3650, the method may include, in response to the UX data being related to the offering data, generating the advertisement data by the AI engine. At 3660, the method may include transmitting the advertisement data to the consumer device. The consumer device may use the advertisement data to display a customized advertisement of the product or service to the consumer.

When implemented in connection with the method from FIG. 35, the AI engine may determine whether a portion of the consumer's schedule is related to the offering data, e.g., at 3510. In response to the portion of the consumer's schedule being related to the offering data, the AI engine may generate the advertisement data with a timing component, e.g., at 3520.

In some implementations, the UX data may indicate a chronotype of the consumer. In some implementations, the UX data may indicate the UX is based on an influencer UX. The offering data may indicate the product or service is promoted by an influencer associated with the influencer UX. The AI engine may be trained to determine the UX data is related to the offering data based on the UX data and the offering data being indicative of the influencer. In some implementations, the UX data may indicate the UX is objective-oriented. The AI engine may be trained to determine the offering data is related to the UX data in response to determining the product or service is related to an objective of the consumer indicated by the UX data.

As a specific example, the offering data may be associated with a specific product offered for sale, such as a new car. The UX data may indicate the consumer has set a goal of saving for a new vehicle. For example, the UX data may indicate that every Friday, the user transfers money from a checking account to a savings account. Other UX data, such as calendar data or budget data, may also be used to determine the consumer's goal. The UX data may indicate the consumer has searched for a new car in a web browser or classified ad application. Based on this data, the AI engine may generate an advertisement tailored for the user. The advertisement may note that the user is saving for a new car and recommend the specific product indicated in the offering data based on the consumer's browsing history.

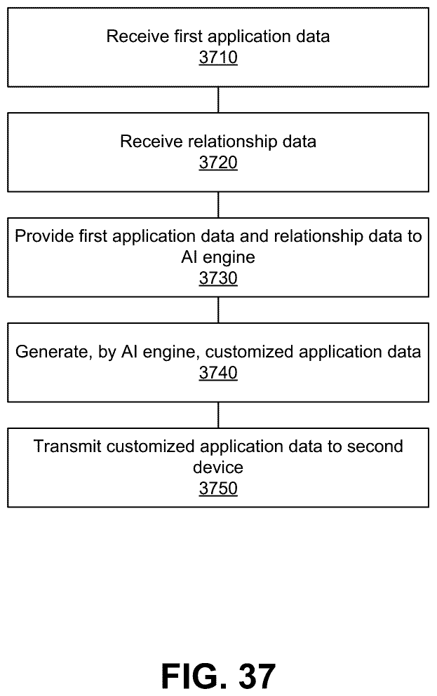

FIG. 37 is a flowchart that describes a method of determining application content based on user relationships, according to some implementations of the present disclosure. In some implementations, at 3710, the method may include receiving first application data that indicates how a first user has used an application installed on a first device associated with the first user. At 3720, the method may include receiving relationship data that indicates a relationship between the first user and a second user associated with a second device. At 3730, the method may include providing the first application data and the relationship data to an AI engine. The AI engine may be trained to generate customized application data based on an activity of the first user indicated by the first application data and further appropriate for the relationship between the first user and the second user as indicated by the relationship data. At 3740, the method may include generating, by the AI engine, the customized application data. At 3750, the method may include transmitting the customized application data to the second device.

In some implementations, the customized application data, when implemented on the second client device, may enable the second user to improve or reinforce the relationship between the first user and the second user. The customized application data may be used by the second device to display application content to the second user that enables the second user to improve or reinforce the relationship.

In some implementations, the relationship data may include one or more of communication data, location data, and type data. The communication data may indicate an amount or frequency of communication between the first user and the second user. The location data may indicate proximity or colocation of the first device and the second device. The type data may indicate a type of the relationship. In some implementations, the first application data may correspond to a schedule or calendar of the first user. The first application data may indicate an activity engaged in by the first user.

In some implementations, the application content may include a recommendation of a product or a service related to the activity engaged in by the first user. In some implementations, the application content may include a recommendation of an activity for the second user related to the activity engaged in by the first user. In some implementations, the first application data may be generated by a first instance of an application-level operating system implemented on the first device. The relationship data may be generated by the first instance and a second instance of the application-level operating system, the second instance implemented on the second device. In some implementations, the first application data may indicate a chronotype of the first user. The AI engine may be trained to generate the customized application data based on the chronotype of the first user.

As a specific example, the first user may have an application installed on their device for a particular organization, such as a car owner's group. The relationship data may indicate the first user and second user are neighbors, e.g., via frequent colocation during non-business hours and/or via the type data. The first application data may indicate the first user attends a car show associated with the car owner's group. The AI engine may generate calendar application data for the second user recommending the second user attend the car show with their neighbor to improve their relationship. The calendar application data may be transmitted to the second user's device.

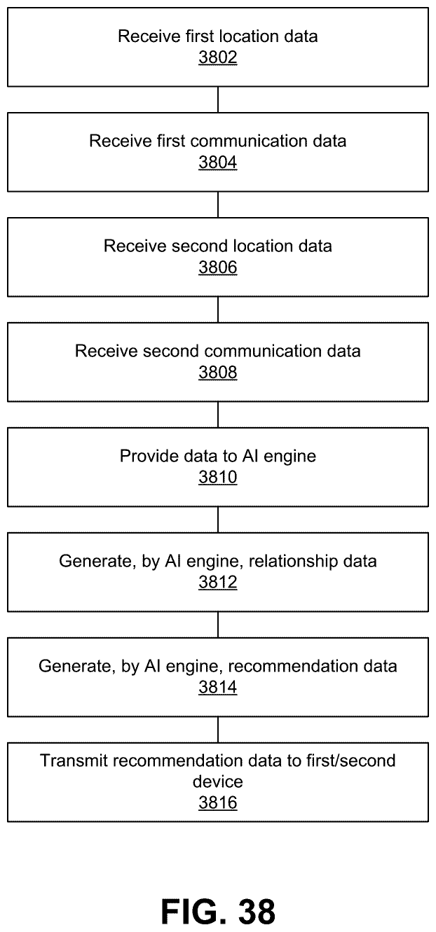

FIG. 38 is a flowchart that describe a method of determining application content based on user relationships, according to some implementations of the present disclosure. In some implementations, at 3802, the method may include receiving first location data associated with a first device. The first location data may indicate where, when, and/or how long the first device was located at a first location. At 3804, the method may include receiving first communication data associated with the first device. The first communication data may indicate a frequency or amount of communication of the first device with a first set of other user devices. At 3806, the method may include receiving second location data associated with a second device. The second location data may indicate where, when, and/or how long the second device was located at a second location. At 3808, the method may include receiving second communication data associated with the second device. The second communication data may indicate a frequency or amount of communication of the second device with a second set of other user devices.

In some implementations, at 3810, the method may include providing the first location data, the first communication data, the second location data, and the second communication data to an AI engine. The AI engine may be trained to determine a relationship between a first user associated with the first device and a second user associated with the second device. At 3812, the method may include generating, by the AI engine, relationship data indicative of the relationship. At 3814, the method may include generating, by the AI engine, recommendation data based on the relationship data. The recommendation data may correspond to a recommendation of an activity for the first user to improve or reinforce the relationship. At 3816, the method may include transmitting the recommendation data to the first device and/or the second device.

In some implementations, the method may include receiving relationship type data that indicates a type of relationship between the first user and the second user. The AI engine may be further trained to determine the relationship based on the relationship type data. In some implementations, the relationship data or the recommendation data may correspond to an application-level operating system. The application-level operating system may use the relationship data or the recommendation data to generate module data for one or more modules operating in the application-level operating system.

In some implementations, the method may be implemented by one or more instances of an application-level operating system. The application-level operation system may include one or more of a device module, an application module, a UX module, and a display module.

As a specific example, the communication data may indicate the first and second user are related, such as in a parent-child relationship. For example, text messages between the users may indicate one user calls the other “mom” or “dad.” The location data may indicate the users are infrequently near each other, such as indicating the parent and child live in different states. Alternatively, the location data may indicate the users live together. The AI engine may generate relationship data that indicates the users have a parent-child relationship and live in different states. The AI engine may, based on the relationship data, generate recommendation data that, when implemented on the users' devices, may help strengthen the relationship. For example, the recommendation data may include a reminder to send a text message. As a more specific example, the recommendation data may include a reminder that says “say hi to mom.” The recommendation data may include a timing component, such as by generating a calendar reminder to send the text message. The recommendation data may include automatically generating the text message or other application content associated with the recommendation. In an example where the users are work colleagues, the recommendation data may include prompting a user about the other user's favorite lunch spot, which may be indicated in the location data.

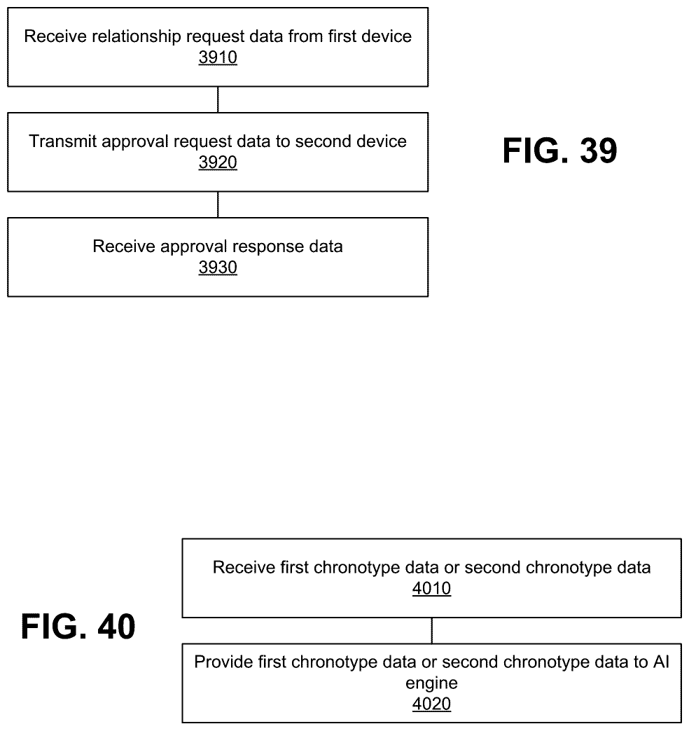

FIG. 39 is a flowchart that further describes the method of determining application content from FIG. 38, according to some implementations of the present disclosure. The method may include privacy controls that allow the users to control whether their data is used to generate the relationship or recommendation data. In some implementations, at 3910, the method may include receiving relationship request data corresponding to a request to generate the relationship data or the recommendation data. The relationship data or the recommendation data may be generated in response to receiving the relationship request data. In some implementations, the request data may correspond to a request by the first user to generate the relationship data or the recommendation data. At 3920, the method may include transmitting approval request data to the second device. The approval request data may correspond to an approval request of the second user to approve generating the relationship data or the recommendation data. At 3930, the method may include receiving approval response data from the second device. The approval response data may correspond to a response by the second user to the request. The relationship data or the recommendation data may be further generated in response to the approval response data indicating the request by the first user and/or the approval by the second user.

FIG. 40 is a flowchart that further describes the method of determining application content from FIG. 38, according to some implementations of the present disclosure. In some implementations, the relationship data or the recommendation data may be based on first chronotype data corresponding to a chronotype of the first user or second chronotype data corresponding to a chronotype of the second user. At 4010, the method may include receiving the first chronotype data or the second chronotype data. At 4020, the method may include providing the first chronotype data or the second chronotype data to the AI engine. The AI engine may generate the relationship data and/or the recommendation data based on either or both chronotype data, e.g., at 3812 and/or 3814. For example, the first and second chronotype data may indicate the users have the same chronotype. The recommendation data may indicate a recommendation for an activity that aligns with the users' chronotypes. As another example, the first and second chronotype data may indicate the users have different chronotypes. The recommendation data may indicate a recommendation for an activity during a period that overlaps with the first and second users' chronotypes.

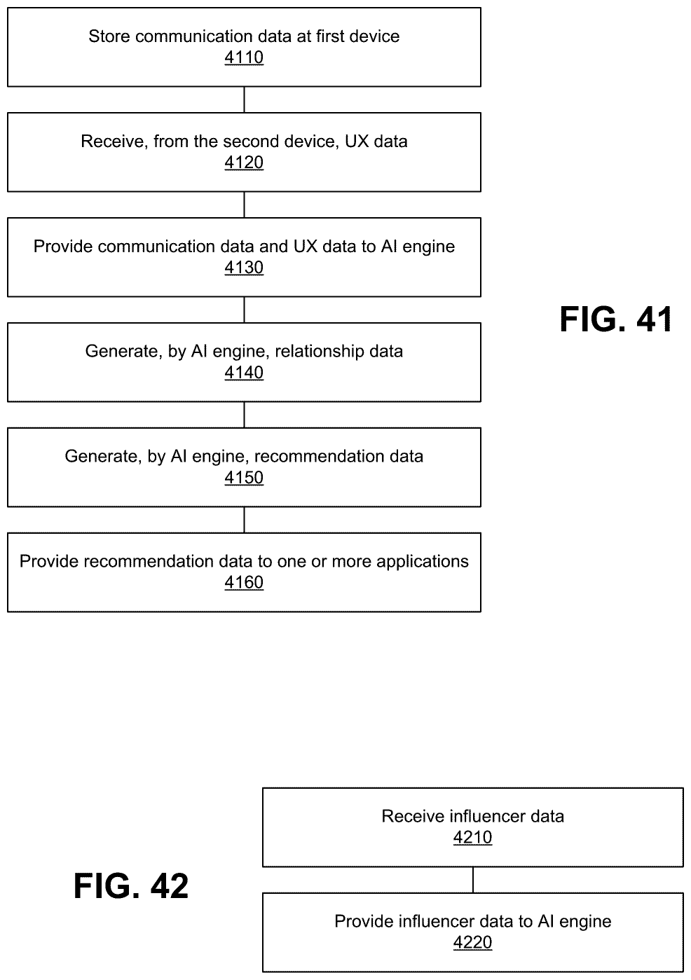

FIG. 41 is a flowchart that describes a method of determining application content based on user relationships, according to some implementations of the present disclosure. In some implementations, at 4110, the method may include storing, at a first device, communication data corresponding to communications between the first device and a second device. At 4120, the method may include receiving, from the second device, UX data that indicates how the second device is used. At 4130, the method may include providing the communication data and the UX data to an AI engine. The AI engine may be trained to generate, based on the communication data or the UX data, relationship data indicative of a relationship between a first user associated with the first device and a second user associated with the second device. At 4140, the method may include generating, by the AI engine, the relationship data. The AI engine may be trained to generate, based on one or more of the communication data, the UX data, or the relationship data, recommendation data corresponding to a recommendation of one or more activities for improving or reinforcing the relationship between the first user and the second user. At 4150, the method may include generating, by the AI engine, the recommendation data. At 4160, the method may include providing the recommendation data to one or more applications installed on the first device. The one or more applications may use the recommendation data to generate application content displayable on the first device.

In some implementations, the UX data may indicate a chronotype of the second user. In some implementations, one or more of the relationship data and the recommendation data may be based on the chronotype of the second user. The AI engine may be trained to determine the chronotype of the second user based on the UX data. In some implementations, the one or more applications may include a calendar application.

As a specific example, the communication data may indicate the users are close friends. For example, the communication data may indicate the users text each other frequently every day, refer to each other by name, and frequently discuss a variety of topics such as other friends, pop culture, activities and schedules, and so forth. The UX data may indicate the second user is interested in astrology. For example, the UX data may indicate the second user frequently uses an astrology application on their phone, or receives frequent emails from an astrology website. Based on the UX data and the relationship data, the AI engine may generate calendar data for the calendar application that notifies the first user of astrological events relevant to the second user.

FIG. 42 is a flowchart that further describes the method of determining application content from FIG. 41, according to some implementations of the present disclosure. In some implementations, at 4210, the method may include receiving influencer data corresponding to an influencer followed by the second user. At 4220, the method may include providing the influencer data to the AI engine. The AI engine may be trained to generate the recommendation data or the relationship data based at least in part on the influencer data. For example, the second user may have implemented on their device a UX based on an influencer's UX. The AI engine may generate recommendation data for the first user, such as a notification of an upcoming event for the influencer. The recommendation data may indicate the recommendation is tied to the relationship with the second user. As a specific example, the recommendation data may be used on the first device to generate an advertisement for the upcoming event with words like, “Invite [X] to [influencer's] upcoming event.”

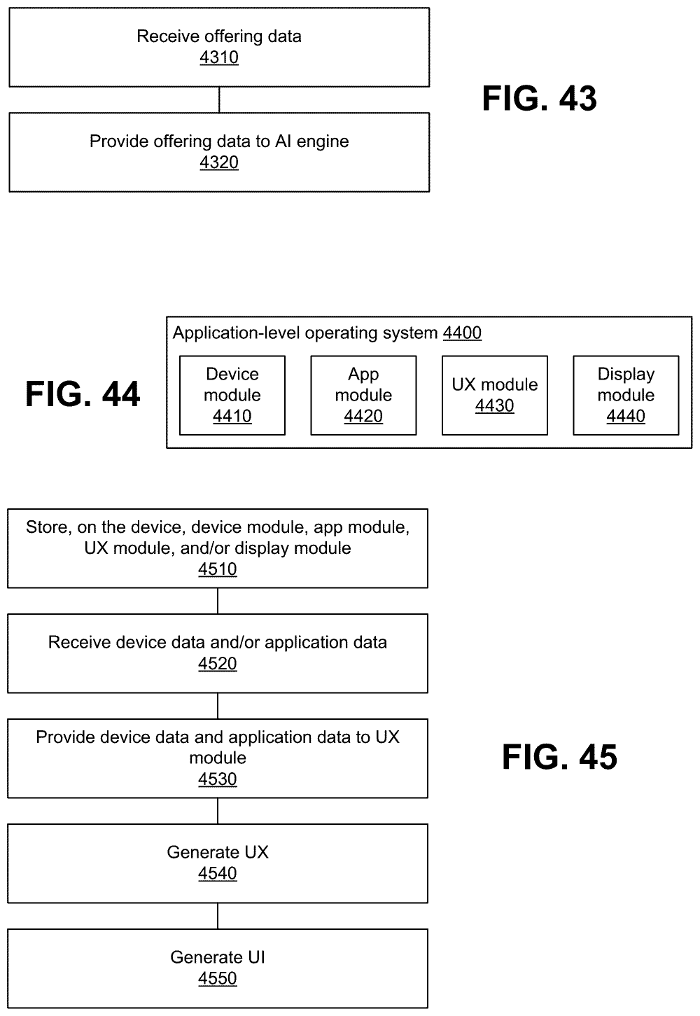

FIG. 43 is a flowchart that further describes the method of determining application content from FIG. 41, according to some implementations of the present disclosure. In some implementations, at 4310, the method may include receiving, at the first device, offering data that corresponds to one or more products or services offered for sale. At 4320, the method may include providing the offering data to the AI engine. The relationship data or the recommendation data may be based in part on the offering data. For example, the offering data may correspond to a service offering, such as salon services. The UX data of the second device may indicate the second user regularly uses the salon services. The relationship data may indicate this, and the recommendation data may recommend the first user schedule a salon date with the second user in connection with recommending the specific salon services associated with the offering data.

FIG. 44 is a block diagram that describes an application-level operating system 4400, according to some implementations of the present disclosure. The application-level operating system may implement one or more of the methods disclosed herein. The application-level operating system may include instructions for implementing one or more of the methods disclosed herein. In some implementations, the application-level operating system 4400 may include a device module 4410. The device module 4410 may communicate with a native operating system of a device on which the application-level operating system may be installed.

The application-level operating system may include an application module 4420 that communicates with a plurality of applications installed on the device. The application-level operating system may include a UX module 4430 that generates a UX based on device data communicated from the native operating system to the application-level operating system 4400 and/or application data communicated from the plurality of applications. The application-level operating system 4400 may include a display module 4440 that generates a UI on the device based on the UX.

In some implementations, the application-level operating system 4400 may include an AI engine implemented in the UX module 4430. The device data or the application data may be provided to the AI engine. The AI engine may be trained to generate UX data, which may be used by the UX module 4430 to generate the UX. In some implementations, the UX may be further based on chronotype data corresponding to a chronotype of a user of the device. In some implementations, the UX may include an objective-oriented UX.

In some implementations, the AI engine may be trained to determine the chronotype of the user based on the application data or the device data. For example, the application data may indicate the user sets morning alarms early in the morning, and the device data may indicate that the device starts charging early in the evening and continues charging until the alarm in the early morning. The AI engine may be trained to generate the chronotype data. For example, the AI engine may be trained to generate chronotype data based on the foregoing application and device data that indicates the user has a morningness chronotype.

In some implementations, the operating system may include an AI engine implemented in the application module 4420. The AI engine may be trained to determine first application content and generate first content data based on second application content. The first application content may correspond to a different application from the second application content. In some implementations, the second application content may correspond to a calendar application, and the first application content may correspond to a non-calendar application. For example, the calendar application may include a calendar event for an upcoming softball game for the user. The AI engine may generate a recommendation in a shopping application that may recommend the user purchase beer for the upcoming softball game.

FIG. 45 is a flowchart that describes a method of implementing an application-level operating system on a device, according to some implementations of the present disclosure. In some implementations, at 4510, the method may include storing, on the device, a device module, a calendar module, a UX module, and a display module. At 4520, the method may include receiving device data from the device module and application data from one or more of a plurality of applications installed on the device. At 4530, the method may include providing the device data and the application data to the UX module. At 4540, the method may include generating a UX for the device based on the device data and/or the application data. At 4550, the method may include generating a UI for the device based on the UX.

In some implementations, all aspects of the UX may be based on calendar data. For example, the device data and the application data may be integrated with the calendar data based on when the user uses features of the device or applications. The UX may evolve throughout a particular day, or based on a particular day, based on how the user uses their device and applications. For example, the user may exercise in the morning and listen to music while exercising. The UX may include a music widget and an exercise widget on a first screen in the morning. After the user exercises, the user may drive to work. The UX may update to remove the music and exercise widgets and instead show, on the first screen, a map widget that shows traffic and/or travel time. Once the user arrives at work, as indicated by device data, e.g., location data, the UX may update to show the user's meetings and tasks for work. At lunch time, the UX may update to recommend the user take a colleague to lunch at their favorite lunch spot. In the evening, the UX may update to show events for the user's children, e.g., extracurricular activities, and/or recommend shopping items for dinner. Based on device data and/or application data that indicates the user goes to bed at a particular time, the UX may update with home security prompts, such as a prompt to set an alarm.

The UI may update as the UX updates. For example, the UI may have different color schemes based on the time of day and aligned with the user's chronotype. The UI may change based on an urgency associated with a particular aspect of the UX. For example, the UI may include a notification sound and a pop-up when the user is driving home reminding the user to order products from the store for dinner that they can pick up on their way home. The UI may change to subdued colors at bedtime that help the user switch their mentality to bedtime mode.

In some implementations, the plurality of applications may comprise one or more of a communication application, a health application, a finance application, and an availability application. In some implementations, the method may include receiving influencer data associated with a subscription by a user of the device to an influencer UX. The UX may be further generated based on the influencer data. In some implementations, the method may include receiving offering data associated with a product or a service. The UX may be further generated based on the offering data.

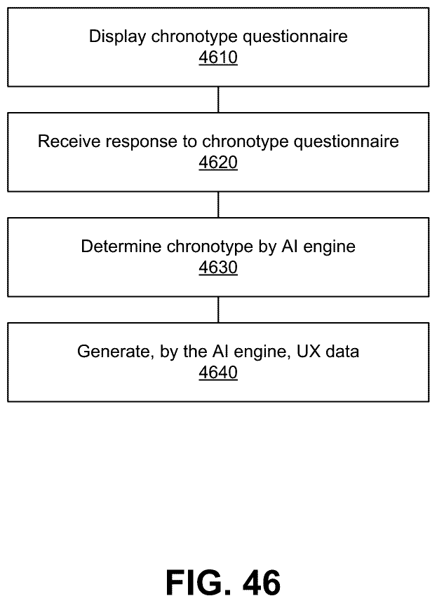

FIG. 46 is a flowchart that further describes the method of implementing an application-level operating system on a device from FIG. 45, according to some implementations of the present disclosure. In some implementations, the UX may be based at least in part on a chronotype of a user associated with the device. At 4610, the method may include displaying a chronotype questionnaire. At 4620, the method may include receiving a response to the chronotype questionnaire. The response may be received by the AI engine. The response may be provided to the AI engine. The AI engine may be trained to determine the chronotype based on the response. At 4630, the method may include determining, by an AI engine, the chronotype based on the response. At 4640, the method may include generating, by the AI engine, UX data based on the chronotype. The UX data may be used by the UX module to generate the UX.

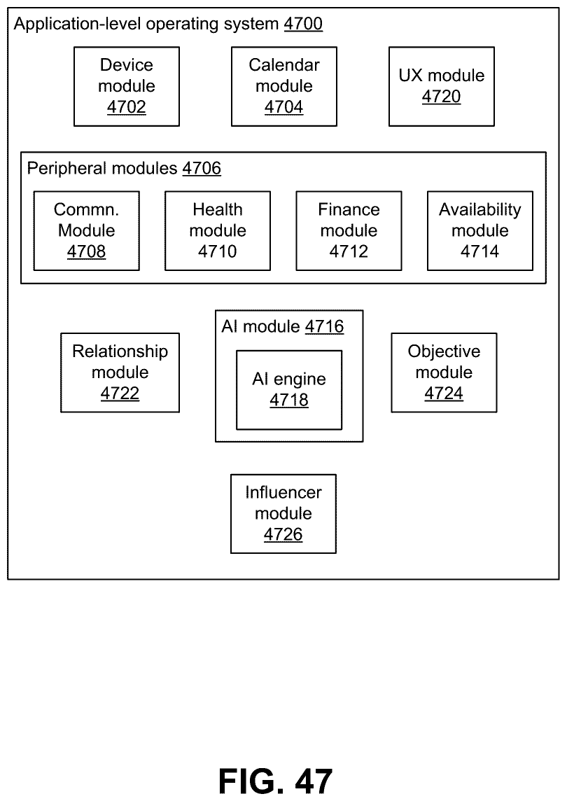

FIG. 47 is a block diagram that describes an application-level operating system 4700, according to some implementations of the present disclosure. In some implementations, the application-level operating system 4700 may include a device module 4702 that communicates with a native operating system of a device on which the application-level operating system may be installed. In some implementations, the device module 4702 may generate device data. The application-level operating system 4700 may include a calendar module 4704 that generates calendar data, peripheral modules 4706, an AI module 4716, and a UX module 4720 that generates a customized UX based the device data and UX data.

In some implementations, the peripheral modules 4706 may include one or more of a communication module 4708, a health module 4710, a finance module 4712, and an availability module 4714. The peripheral modules 4706 may be governed by the calendar module 4704. The AI module 4716 may include an AI engine 4718 that may be trained to generate the UX data based on the calendar data. The device module 4702, the calendar module 4704, the peripheral modules 4706, the AI module 4716, and the UX module 4720 may be configured to communicate with each other. The calendar data may include peripheral data corresponding to the peripheral modules 4706.

In some implementations, the AI engine 4718 may be trained to generate activity data corresponding to one or more of the communication module 4708, the health module 4710, the finance module 4712, and the availability module 4714. The UX data may be further based on activity data associated with one or more of the peripheral modules 4706. In some implementations, the AI engine 4718 may be trained to determine a chronotype of a user of the device based on a chronotype questionnaire. The AI engine 4718 may be trained to generate chronotype data indicative of the user's chronotype. The UX data may be based at least in part on the chronotype data.

In some implementations, the operating system may include a relationship module 4722. The relationship module 4722 may communicate with the AI module 4716. The relationship module 4722 may generate relationship data corresponding to a relationship between a user of the device and a user of another device. The AI engine 4718 may be trained to generate the UX data based at least in part on the relationship data. In some implementations, the operating system may include an objective module 4724. The objective module 4724 may communicate with the AI module 4716. The objective module 4724 may generate objective data corresponding to a personal or lifestyle objective of a user of the device. The AI engine 4718 may be trained to generate the UX data based at least in part on the objective data. In some implementations, the operating system may include an influencer module 4726. The influencer module 4726 may communicate with the AI module 4716. The influencer module 4726 may generate influencer data. The AI engine 4718 may be trained to generate the UX data based at least in part on the influencer data.

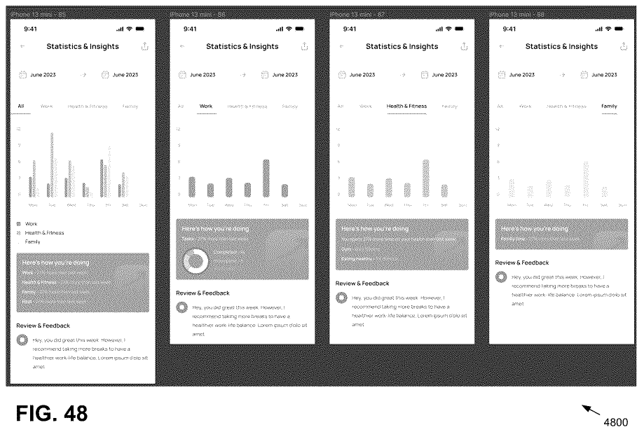

FIG. 48 illustrates a user statistics display 4800, according to an implementation. In various implementations, a digital, AI-driven lifestyle management system may track data indicative of how a user spends their time for a certain period. In some implementations, the data may be categorized. For example, in some implementations, the data may be categorized as “Work” time, “Health & Fitness” time, and/or “Family” time. Data may be categorized to a single category or multiple categories. For example, a user may have a physically demanding job, or may have a job that requires the user to be physically fit and exercise, such as a user in the military or a user who works as a firefighter. The user may exercise while at work, and data indicative of exercise during work hours may be categorized as both “Work” and “Health & Fitness.” The data may be displayed according to how much time during the period the user spent engaging in an activity related to a category. The data may be displayed according to what percentage of the period the user spent engaging in an activity related to a category. The data may be displayed relative to a comparison of a previous period's data. The data may be displayed relative to an objective or goal of the user stored in the system.

In various implementations, a user may create their own categories for monitoring how they spend their time. In some implementations, the categories may be generated automatically, such as by an AI engine trained to determine categories for activities. For example, the AI engine may be trained to categorize an activity based on the application from which the data was obtained. As a specific example, the AI engine may be trained to categorize an activity as “Work” based on application data showing the user was using a work-related application. The AI engine may be trained to categorize an activity based on what the data indicates about the user. As a specific example, the AI engine may be trained to categorized an activity as “Health & Fitness” when the data indicates the user has a heart rate above 120 beats per minute.

The digital, AI-driven lifestyle management system may provide prompts to a user based on the activity data. In some implementations, the prompts may be related to one or more objectives of the user. For example, objective data may indicate the user has a goal of spending more time with family. The prompt may include a natural language prompt, such as one generated by an AI engine, with advice on how the user can get closer to their goal.

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e. methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. The specific details set forth above are merely examples. Particular implementations may vary from these details and still be contemplated to be within the scope of the present implementations.

Related elements in the examples and/or implementations described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements and/or properties may be claimed through amendment of those claims or presentation of new claims in the present application or in a related application. Such amended or new claims, whether they are directed to the same example or a different example and whether they are different, broader, narrower or equal in scope to the original claims, are to be considered within the subject matter of the examples described herein.

We claim:

1. A method of automatically generating a calendar entry based on usage of a device, comprising:
automatically determining, by the device, a usage state of an application on the device for a first date and time period;
automatically determining, based on the usage state, a user activity for the first date and time period; and
automatically generating, based on the usage state, the calendar entry for a second date and time period similar to the first date and time period of the user activity, wherein the calendar entry comprises an activity name and a duration.

2. The method of claim 1, comprising:
automatically determining a current date and time; and
in response to the current date and time matching the calendar entry, automatically setting the application to the usage state.

3. The method of claim 1, comprising:
automatically determining a location of the device for the first date and time period; and
automatically determining the user activity further based on the location.

4. The method of claim 3, comprising automatically generating the calendar entry further based on the location.

5. The method of claim 1, comprising:
automatically determining a location of the device for the first date and time period;
automatically determining the user activity further based on the location;
automatically determining a current date and time and a current location; and
in response to the current date and time matching the calendar entry, and further in response to the current location matching the location of the device for the first date and time period, automatically setting the application to the usage state.

6. The method of claim 1, wherein the method is implemented by an application-level operating system of the device, and wherein the application-level operating system comprises:
a device module that communicates with a native operating system of the device;
an application module that communicates with the application;
a user experience (UX) module that generates a UX based on device data communicated from the native operating system to the application-level operating system and application data communicated from the application; and
a display module that generates a user interface on the device based on the UX.

7. The method of claim 1, comprising displaying the calendar entry on the device via a calendar application on the device that is implemented according to a customized display and UX based on a chronotype of a user associated with the device.

8. A method of generating a composite calendar based on a scheduled activity and an unscheduled activity, comprising:
displaying, via a user interface (UI) of a device, a calendar interface associated with a calendar module implemented on the device;
receiving, via the calendar interface, an input corresponding to a first calendar entry;
storing the first calendar entry on the device;
automatically determining, by the device, a usage state of the device for a first date and time period associated with the first calendar entry;
automatically determining, based on the usage state, a user activity for the first date and time period;
automatically generating, based on one or more of the usage state and the first calendar entry, a second calendar entry for a second date and time period similar to the first date and time period; and
storing the second calendar entry on the device, wherein:
the calendar interface shows the first calendar entry after the first calendar entry is generated; and
the calendar interface shows the second calendar entry after the second calendar entry is generated.

9. The method of claim 8, wherein the first calendar entry comprises a first device usage entry that indicates the usage state of the device for the first calendar entry, or wherein the second calendar entry comprises a second device usage entry that indicates the usage state of the device for the second calendar entry.

10. The method of claim 9, comprising:
automatically determining, by the device, a current date and time;
in response to the current date and time matching the first calendar entry, automatically setting the device to the usage state for the first calendar entry; and
in response to the current date and time matching the second calendar entry, automatically setting the device to the usage state for the second calendar entry.

11. The method of claim 9, comprising:
automatically determining, by the device, a current date and time and a current location of the device, wherein the first calendar entry comprises an event location; and
in response to the current date and time and the current location matching the first calendar entry, automatically setting the device to the usage state for the first calendar entry.

12. The method of claim 9, comprising:
automatically determining a location of the device for the first date and time period, wherein generating the second calendar entry further comprises generating an event location that matches the location of the device for the first date and time period;
automatically determining, by the device, a current date and time and a current location of the device; and
in response to the current date and time and the current location matching the second calendar entry, automatically setting the device to the usage state for the second calendar entry.

13. The method of claim 8, wherein the method is implemented by an application-level operating system of the device, and wherein the application-level operating system comprises:
a device module that communicates with a native operating system of the device;
an application module that communicates with a calendar application on the device, wherein the calendar application generates the calendar interface on the UI;
a user experience (UX) module that generates a UX based on device data communicated from the native operating system to the application-level operating system and application data communicated from the calendar application; and
a display module that generates the UI on the device based on the UX.

14. The method of claim 8, wherein the calendar module is implemented on the device according to a customized display and UX based on a chronotype of a user associated with the device.

15. A method of automatically generating a calendar entry based on a function executed in another application on a device, comprising:
automatically determining, by a calendar application implemented on the device, a function executed by the other application on the device, wherein the other application comprises one or more of a communication application, a health application, a finance application, and a task application;
automatically determining, by the calendar application, a user activity for a first date and time period associated with the function; and
automatically generating, based on the user activity, the calendar entry for a second date and time period similar to the first date and time period, wherein the calendar entry comprises an activity name and a duration.

16. The method of claim 15, wherein the calendar application has permissions to read data associated with the other application, create new data in the other application, provide inputs to the other application, and receive outputs from the other application.

17. The method of claim 15, comprising:
automatically determining, by the calendar application, a current date and time; and
in response to the current date and time matching the calendar entry, automatically executing the function by the other application.

18. The method of claim 15, comprising automatically determining a location of the device for the first date and time period, wherein generating the calendar entry further comprises generating an event location that matches the location of the device for the first date and time period.

19. The method of claim 18, comprising:
automatically determining, by the calendar application, a current date and time and a current location of the device; and
in response to the current date and time and the current location matching the calendar entry, automatically executing the function by the other application.

20. The method of claim 15, wherein the calendar application is implemented on the device according to a customized display and UX based on a chronotype of a user associated with the device.
